(19) United States
(12) Patent Application Publication
(10) Pub. No.: US 2026/0361509 A1
(43) Pub. Date: Nov. 12, 2026

(54) SYSTEM AND METHOD FOR TOKENIZING CRITICAL MINERAL RESERVES USING A MULTI-LAYER BLOCKCHAIN ARCHITECTURE WITH ZERO-KNOWLEDGE PROOF VERIFICATION AND PROGRAMMABLE ESCROW

(71) Applicant: Edward Aramovich Manoukian, Liberty, MO (US)

(72) Inventor: Edward Aramovich Manoukian, Liberty, MO (US)

(73) Assignee: Edward Aramovich Manoukian, Liberty, MO (US)

(21) Appl. No.: 19/675,388

(22) Filed: May 12, 2026

Related U.S. Application Data
(60) Provisional application No. 63/835,006, filed on May 12, 2025.

(51) Int. Cl. H04L 9/06; G06Q 30/018

(52) U.S. Cl. CPC H04L 9/0643; G06Q 30/018

(57) ABSTRACT

A system and method convert independently audited critical mineral reserve data into a collateralized digital token using a four-layer hybrid blockchain architecture. A first permissioned distributed ledger layer executes Foreign Entity of Concern, Environmental Social and Governance, and audit-standard chaincode validation and records a cryptographic hash of each audit document. A second decentralized oracle computation layer retrieves commodity prices, enforces a defined over-collateralization threshold, and generates a zero-knowledge collateral sufficiency proof. A third permissioned settlement layer issues, redeems, and burns tokens under a multi-signature governance threshold drawn from a plurality of supply chain participant classes, restricts transfers to wallets holding audit-gated trustline authorization, and maintains a token data structure storing three-tier collateral references and zero-knowledge-verified compliance flags. A fourth public attestation layer records workflow commitment hashes and zero-knowledge proof outputs. A programmable escrow subsystem releases locked tokens only upon zero-knowledge proof verification, incapable of off-chain override.

### CROSS-REFERENCE TO RELATED APPLICATIONS

This nonprovisional utility patent application claims the benefit of priority under 35 U.S.C. § 119(e) to U.S. Provisional Patent Application No. 63/835,006, filed May 12, 2025, and to U.S. Provisional Patent Application No. 64/056,244, filed May 4, 2026, each by inventor Edward Aramovich Manoukian. The entire disclosure of each of the foregoing provisional applications, including the specification, drawings, and any claims appearing therein, is incorporated herein by reference in its entirety pursuant to 37 C.F.R. § 1.57(b). Subject matter first disclosed in U.S. Provisional Patent Application No. 63/835,006 is entitled to a priority date of May 12, 2025; subject matter first disclosed in U.S. Provisional Patent Application No. 64/056,244 is entitled to a priority date of May 4, 2026; and subject matter first disclosed in the present application is entitled to the filing date of the present application.

### STATEMENT REGARDING FEDERALLY SPONSORED RESEARCH OR DEVELOPMENT

Not applicable. The subject matter of this application was developed by the inventor and applicant using private resources and was not made with United States Government support. No federal agency has rights in the disclosed subject matter.

Given the architectural breadth of the embodiments disclosed herein, the present application is the first in a planned series of related applications. One or more continuation applications under 35 U.S.C. § 120, or divisional applications under 35 U.S.C. § 121, are contemplated to claim additional embodiments disclosed but not claimed herein, with priority benefit preserved through this application and through the foregoing provisional applications by reference.

### NAMES OF THE PARTIES TO A JOINT RESEARCH AGREEMENT

Not applicable.

### INCORPORATION BY REFERENCE OF MATERIAL SUBMITTED ON COMPACT DISC

Not applicable. No computer program listing, sequence listing, or large tabular data appendix is submitted with this application.

### COPYRIGHT NOTICE

A portion of the disclosure of this patent document may contain material that is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever. This notice is given pursuant to 37 C.F.R. § 1.71(d) and (e).

### TECHNICAL FIELD

The present disclosure relates to distributed ledger technology, applied cryptography, and oracle-mediated smart contract systems, and more particularly to systems and methods for converting independently audited critical mineral reserve data into a collateralized digital token instrument through a multi-layer hybrid blockchain architecture in which audit validation, basket valuation, settlement, and public attestation are partitioned across distinct distributed ledger platforms and bridged by zero-knowledge cryptographic proofs.

### BACKGROUND

Critical mineral commodities, including without limitation lithium, cobalt, nickel, copper, graphite, and rare earth elements, are indispensable inputs to electric vehicle battery cells, defense systems, renewable energy infrastructure, advanced semiconductors, and permanent magnets. The 2025 United States Geological Survey List of Critical Minerals (90 Fed. Reg. 47,265, Nov. 7, 2025) designates sixty mineral commodities as critical to United States economic and national security. Demand for these mineral commodities is projected to increase substantially through 2040, driven by electric vehicle adoption, defense procurement, renewable energy buildout, and advanced semiconductor manufacturing.

Despite the demonstrated economic value of independently audited critical mineral reserves, the average time between discovery of a critical mineral deposit and commencement of commercial production in the United States exceeds sixteen years. During this multi-decade development cycle, the holder of an independently audited mineral reserve has had limited mechanisms by which to represent the latent financial value of the reserve as a programmable digital instrument prior to extraction. A parallel gap has existed for certified secondary material streams, including without limitation battery black mass, end-of-life electronics yields, and industrial mineral by-products, which generate verifiable mineral inventory but have lacked a standardized digital representation suitable for supply chain settlement.

Various prior approaches have attempted to represent physical commodity value as a digital token on a distributed ledger. Such approaches have generally exhibited one or more of the following limitations. First, prior commodity tokenization systems have relied upon a single-ledger architecture, exposing the entire workflow: audit data, valuation, settlement, and public record creating a single trust domain and a single failure mode. Second, prior systems have either disclosed reserve composition data on a public ledger, compromising the commercial confidentiality of the reserve holder, or have concealed reserve composition data entirely, with the result that no third party is able to cryptographically verify that issued tokens are in fact backed by sufficient collateral. Third, prior systems have conditioned wallet authorization on identity verification alone, without conditioning authorization on the substantive geological audit standing or sourcing compliance posture of the wallet holder. Fourth, prior systems have not provided cryptographic verification that statutory sourcing-compliance criteria, such as Foreign Entity of Concern designation under 26 C.F.R. § 1.30D-6, are satisfied at the time of token issuance and at each subsequent transfer.

Representative prior approaches include the system disclosed in U.S. Pat. No. 11,893,626 to Youb et al. (issued Feb. 6, 2024, assigned to IP Oversight Corporation), which discloses a smart-contract token backed by a mine having proven available reserves on a single-ledger architecture, and the system disclosed in U.S. Patent Application Publication No. 2025/0078162 to Doney et al. (published Mar. 6, 2025, assigned to DTCC Digital (US) Inc.), which discloses a tokenized-asset data structure for cross-chain settlement of financial assets. Additional prior art is identified on the Information Disclosure Statement filed concurrently with this application pursuant to 37 C.F.R. § 1.97 and § 1.98.

A need has existed for a digital token system that integrates audit-validated reserve collateralization, multi-platform cross-ledger message routing, cryptographic verification of compliance conditions without disclosure of underlying proprietary data, and audit-conditioned wallet authorization, within a single architecture suitable for institutional and sovereign deployment.

### SUMMARY OF THE EMBODIMENTS

The following summary introduces a selection of concepts that are further described in the Detailed Description below. This summary is not intended to identify essential features of the claimed subject matter, nor to be used in determining the scope of the claimed subject matter. Disclosed implementations provide systems and methods for converting independently audited critical mineral reserve data into a collateralized digital token instrument using a multi-layer hybrid blockchain architecture with zero-knowledge cryptographic proof verification.

In at least one embodiment, a system for converting independently audited critical mineral reserve data into a collateralized stablecoin instrument comprises one or more computer hardware processors, one or more memory devices, and one or more network interfaces collectively configured to implement a first layer, a second layer, a third layer, and a fourth layer. In at least one embodiment, the first layer comprises a permissioned distributed ledger network configured to receive an audit document selected from a geological reserve audit document and a yield audit document, to compute a cryptographic hash of the audit document, to store the audit document in a private data collection of the permissioned distributed ledger network while recording only the cryptographic hash on the distributed ledger, to execute chaincode logic operable to validate Foreign Entity of Concern compliance, Environmental Social and Governance compliance, and audit-standard compliance, and to emit a signed validation event upon concurrent satisfaction of all three compliance conditions.

In at least one embodiment, the second layer comprises a decentralized oracle computation network and a cross-chain interoperability protocol communicatively coupled to the first layer. The second layer is configured, in at least one embodiment, to receive the signed validation event from the first layer, to retrieve commodity price data for each constituent of a governance-weighted basket, to compute a basket value as a weighted sum of (i) audit-validated reserve quantities, (ii) commodity prices adjusted by a jurisdictional risk coefficient and a volatility dampener, and (iii) governance-set allocation weights, to compute a collateral ratio by dividing the basket value by a proposed stablecoin supply quantity, to block any minting authorization where the collateral ratio falls below a defined over-collateralization threshold, and to generate a zero-knowledge collateral sufficiency proof attesting to satisfaction of the over-collateralization threshold without disclosing reserve quantities, mineral grades, or geospatial coordinates.

In at least one embodiment, the third layer comprises a permissioned settlement ledger configured to receive a minting authorization from the second layer through the cross-chain interoperability protocol, to execute stablecoin token issuance, redemption, and burn operations from a single authoritative issuer account under a multi-signature governance threshold drawn from a plurality of distinct supply chain participant classes, and to restrict token holding, receipt, and transfer to wallets having an active trustline authorization conditioned on validation of the wallet holder's audit status and Foreign Entity of Concern compliance through a Membership Service Provider of the first layer.

In at least one embodiment, the fourth layer comprises a public permissionless attestation contract deployed on a public blockchain and configured to immutably store, for each protocol operation, a workflow commitment hash, outputs of the zero-knowledge collateral sufficiency proof, cross-chain interoperability execution receipts, and governance vote commitment hashes, and to expose a publicly accessible cryptographic verification interface.

In at least one embodiment, every issued stablecoin token is simultaneously collateralized at three tiers comprising a Tier 1 primary collateral position validated through the first layer at a defined minimum over-collateralization ratio, a Tier 2 sovereign guarantee processed through a Sovereign Guarantee Channel of the first layer that is segregated from each audit data channel and each compliance data channel of the first layer, and a Tier 3 federal sovereign reserve backstop designation cryptographically verified through an on-chain proof-of-reserve attestation anchored on the fourth layer.

In at least one embodiment, the second layer is further configured to generate a Collateral Sufficiency Circuit operating at a boundary between the second layer and the third layer. Private inputs to the Collateral Sufficiency Circuit comprise reserve quantities, jurisdictional risk coefficients, and volatility dampeners. Public inputs to the Collateral Sufficiency Circuit comprise oracle prices, governance-set basket allocation weights, and the proposed stablecoin supply quantity. The public output of the Collateral Sufficiency Circuit is a Boolean proof attesting that the collateral ratio satisfies the over-collateralization threshold without revealing the reserve quantities, the jurisdictional risk coefficients, or the volatility dampeners.

In at least one embodiment, a Mineral Reserve Receipt programmable escrow subsystem is integrated within the third layer. The Mineral Reserve Receipt programmable escrow subsystem, in at least one embodiment, comprises a Mineral Reserve Receipt token representing a quantity of stablecoin held in a multi-signature escrow address, on-ledger conditional release logic implemented as hook-based smart logic natively executed on the third layer and operable to release the locked stablecoin to a beneficiary wallet upon receipt of a valid zero-knowledge escrow milestone proof transmitted from the second layer, and an immutable Mineral Reserve Receipt lifecycle record anchored on the fourth layer. In at least one embodiment, the on-ledger conditional release logic is structurally incapable of releasing the locked stablecoin by any pathway other than zero-knowledge-proof-conditioned cross-chain message delivery from the second layer.

In at least one embodiment, a method is provided comprising, by at least one computer processor: receiving an audit document at a permissioned distributed ledger network; computing a cryptographic hash of the audit document and executing chaincode validation; computing a basket value and a collateral ratio at a decentralized oracle computation network; generating a zero-knowledge collateral sufficiency proof; transmitting a minting authorization through a cross-chain interoperability protocol to a permissioned settlement ledger; issuing, redeeming, or burning stablecoin tokens from an authoritative issuer account; transmitting a workflow commitment hash to a public permissionless attestation contract; and monitoring the collateral ratio on a recurring basis with a proportional burn operation upon any breach of the over-collateralization threshold.

In at least one embodiment, a stablecoin token data structure is instantiated and maintained on the permissioned settlement ledger and comprises a token identifier field, a three-tier collateral binding reference field, a zero-knowledge-verified compliance flag field comprising at least three flags each settable only upon successful execution of a corresponding zero-knowledge proof circuit, a multi-signature authorization record field, a trustline authorization record field, and a multi-layer attestation anchoring reference field.

Additional embodiments and features will become apparent from the Detailed Description below taken in conjunction with the accompanying drawings and the appended claims. The embodiments described in this summary and elsewhere in this specification are provided by way of illustration only; the scope of the embodiments is defined by the appended claims.

### BRIEF DESCRIPTION OF THE DRAWINGS

The accompanying drawings, which are incorporated in and constitute a part of this specification, illustrate disclosed implementations and, together with the Detailed Description, serve to explain the principles thereof. The drawings of this application comprise twenty-two drawing sheets, designated FIG. 1, FIGS. 2A and 2B, FIGS. 3A and 3B, FIG. 4, FIG. 5, FIGS. 6A through 6F, FIG. 7, FIG. 8, FIG. 9, FIG. 10, FIG. 11, FIG. 12, FIG. 13, FIG. 14, and FIG. 15, each filed as a separate sheet in accordance with 37 C.F.R. § 1.84. Each drawing is a black-and-white schematic conforming to 37 C.F.R. § 1.84(a) and (l). Like reference numerals are used to refer to like elements throughout the drawings. Specific values, thresholds, and variable relationships depicted in any figure are exemplary and non-limiting.

FIG. 1 is a schematic diagram of a four-layer hybrid blockchain computing architecture for converting independently audited critical mineral reserve data into a collateralized digital token instrument in accordance with disclosed implementations.

FIG. 2A is a flowchart illustrating a first portion of a fourteen-step minting and issuance workflow, comprising Steps 1 through 7 executed at the first layer from audit submission through chaincode validation, in accordance with disclosed implementations.

FIG. 2B is a flowchart illustrating a second portion of the fourteen-step minting and issuance workflow, comprising Steps 8 through 14 executed across the second, third, and fourth layers from basket valuation through multi-signature token issuance to public attestation anchoring, in accordance with disclosed implementations.

FIG. 3A schematically illustrates four parallel burn-mechanism scenarios of the issued token instrument, organized as four columns directed respectively to primary reserve redemption, downward collateral revaluation, programmable escrow expiry, and governance-ratified token retirement, in accordance with disclosed implementations.

FIG. 3B illustrates a basket valuation and dynamic pricing function applied to a governance-weighted basket of mineral commodities, including raw market price inputs, audit-derived reserve inputs, jurisdictional risk adjustment, volatility dampening, collateral ratio computation, and a minting-authorization decision gate, in accordance with disclosed implementations.

FIG. 4 is a schematic illustration of a tiered minting lifecycle comprising a Provisional Reserve Token issuance phase, an atomic Conversion Authorization Event, and a Full Supply Chain Token issuance phase, in accordance with disclosed implementations.

FIG. 5 depicts a schematic view of the lifecycle of a Mineral Reserve Receipt programmable escrow instrument from contract creation through oracle-monitored condition evaluation, zero-knowledge milestone proof generation, hook-based conditional release, and immutable lifecycle anchoring, in accordance with disclosed implementations.

FIG. 6A schematically illustrates an overview of a three-tier sovereign collateral architecture in which Tier 1, Tier 2, and Tier 3 collateral positions converge to support the issued token, in accordance with disclosed implementations.

FIG. 6B illustrates components of a Tier 1 primary geological or yield-audit collateral subsystem of the three-tier sovereign collateral architecture, in accordance with disclosed implementations.

FIG. 6C illustrates components of a Tier 2 state mineral collateral declaration subsystem of the three-tier sovereign collateral architecture, in accordance with disclosed implementations.

FIG. 6D illustrates components of a Tier 3 federal sovereign reserve backstop subsystem of the three-tier sovereign collateral architecture, in accordance with disclosed implementations.

FIG. 6E illustrates a data structure defining the issued token, including a token identifier, a three-tier collateral binding reference, zero-knowledge-verified compliance flags, a multi-signature authorization record, a trustline authorization record, and a multi-layer attestation anchoring reference, in accordance with disclosed implementations.

FIG. 6F is a schematic illustration of a token relationship data model linking an authoritative issuer account through trustline authorizations to a dual-token architecture and to connected wallet tiers, in accordance with disclosed implementations.

FIG. 7 is a function block diagram of five zero-knowledge proof circuits operating at defined inter-layer boundaries of the four-layer hybrid blockchain architecture, in accordance with disclosed implementations.

FIG. 8 schematically illustrates a multi-class governance token architecture comprising a nine-class supply chain participant allocation, a zero-knowledge voting circuit, and a four-layer cross-chain governance execution pipeline, in accordance with disclosed implementations.

FIG. 9 depicts a schematic block diagram of a cloud infrastructure reference architecture supporting the first layer and the second layer, organized into ingestion and preprocessing, blockchain and computation, and state management and compliance bands, in accordance with disclosed implementations.

FIG. 10 is an illustration of a system that facilitates token trading and settlement, including a fiat on-ramp through a state-chartered Special Purpose Depository Institution, an automated market maker pool, restricted and unrestricted token transfer paths, an exchange pathfinding engine, an at-par redemption gateway, and a fiat off-ramp, in accordance with disclosed implementations.

FIG. 11 illustrates operations of a cross-layer message architecture transporting eleven distinct message types across the four-layer hybrid blockchain architecture via a cross-chain interoperability transport bus and through a Risk Management Network validation gate, in accordance with disclosed implementations.

FIG. 12 is a flowchart illustrating a nine-step recycler re-tokenization cycle by which secondary recovered mineral material progresses from dead inventory through yield audit submission, Provisional Reserve Token minting, programmable tolling escrow, processor delivery verification, refined output receipt, a re-tokenization loop, and Conversion Authorization Event exit, in accordance with disclosed implementations.

FIG. 13 illustrates a process to perform document classification, structured field extraction, and participant-class-aware routing by a Mineral Audit Intelligence Engine deployed between a participant access interface and the first layer, in accordance with disclosed implementations.

FIG. 14 illustrates a pricing function comprising oracle price inputs, jurisdictional risk coefficient inputs, volatility dampener inputs, and audit-derived reserve quantity inputs operated upon to compute adjusted constituent prices, a basket value, and a collateral ratio evaluated against a defined over-collateralization threshold at a minting-authorization decision gate, in accordance with disclosed implementations.

FIG. 15 is a function block diagram of an internal architecture and proof generation pipeline of a Collateral Sufficiency Circuit, comprising a Circuit Inputs band, a STARK arithmetization and proof generation band, and an Outputs band, in accordance with disclosed implementations.

### DETAILED DESCRIPTION

### Overview of the Multi-layer Hybrid Blockchain Architecture

The following Detailed Description sets forth specific embodiments of the systems and methods introduced above. In the following description, numerous specific details are provided to enable a person skilled in the relevant art to make and use the embodiments without undue experimentation. In at least one embodiment, however, the embodiments may be practiced without one or more of the specific details, or with substituted or equivalent elements known in the art. Throughout this Detailed Description, the phrases “in at least one embodiment,” “in a preferred embodiment,” “in one implementation,” “in some implementations,” “configured to,” “operable to,” and “adapted to” are used to describe non-limiting aspects of the disclosed embodiments. The use of any such phrase shall not be construed to limit any claim to the particular embodiment or aspect described.

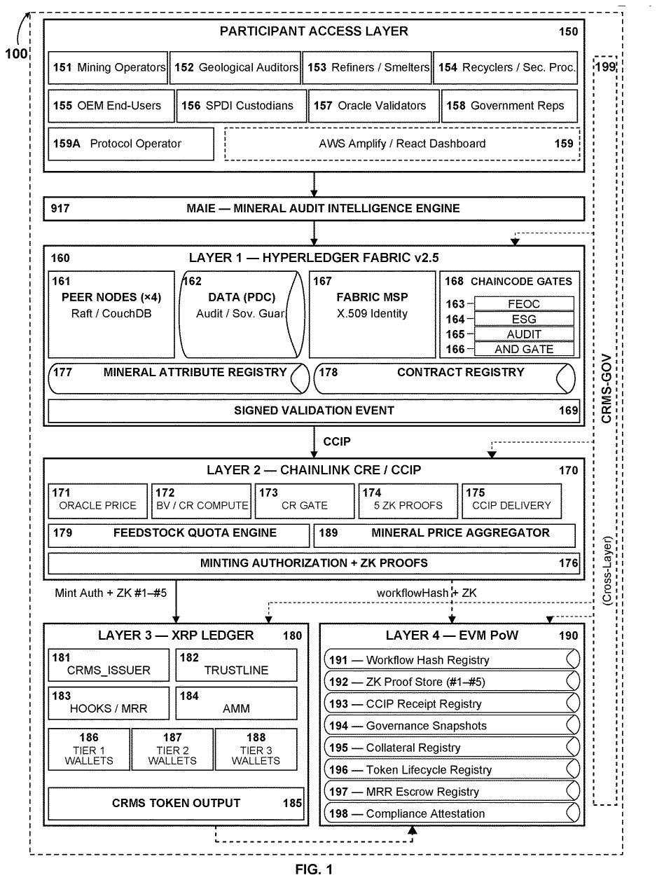

FIG. 1 schematically illustrates a four-layer hybrid blockchain computing architecture 100, in at least one embodiment, for converting independently audited critical mineral reserve data into a collateralized digital token instrument. The architecture 100, in at least one embodiment, comprises a first layer 110, a second layer 120, a third layer 130, and a fourth layer 140, communicatively coupled by a cross-chain interoperability message bus that bridges the first layer 110 through the second layer 120 to the third layer 130, and that anchors workflow commitments and cryptographic proof outputs from the second layer 120 onto the fourth layer 140. In at least one embodiment, the architecture 100 is implemented across one or more computer hardware processors, one or more memory devices, and one or more network interfaces executing program instructions stored on one or more non-transitory computer-readable storage media.

In at least one embodiment, the first layer 110 comprises a permissioned distributed ledger network configured to validate independently audited reserve and yield data and to emit a signed validation event. In at least one embodiment, the second layer 120 comprises a decentralized oracle computation network and a cross-chain interoperability protocol configured to retrieve commodity price data, compute basket value and collateral ratio, generate zero-knowledge proof outputs, and deliver minting authorizations between the first layer 110 and the third layer 130. In at least one embodiment, the third layer 130 comprises a permissioned settlement ledger configured to execute stablecoin token issuance, redemption, and burn operations and to maintain trustline authorizations conditioned on audit and compliance status. In at least one embodiment, the fourth layer 140 comprises a public permissionless attestation contract deployed on a public blockchain and configured to immutably anchor workflow commitments and zero-knowledge proof outputs for public verification.

The four-layer partitioning of FIG. 1 distinguishes the disclosed embodiments from prior single-ledger commodity tokenization systems in which audit data, basket valuation, settlement execution, and public record are co-located on a single distributed ledger and exposed to a single trust domain and a single failure mode. In at least one embodiment, partitioning these functions across discrete trust domains: a permissioned audit network for confidential audit data, a decentralized oracle network for cryptographically attested computation, a permissioned settlement ledger for credentialed token transfer, and a public attestation network for immutable record enabling confidentiality of proprietary geological and yield data while providing public cryptographic verification that issued tokens satisfy defined collateralization conditions.

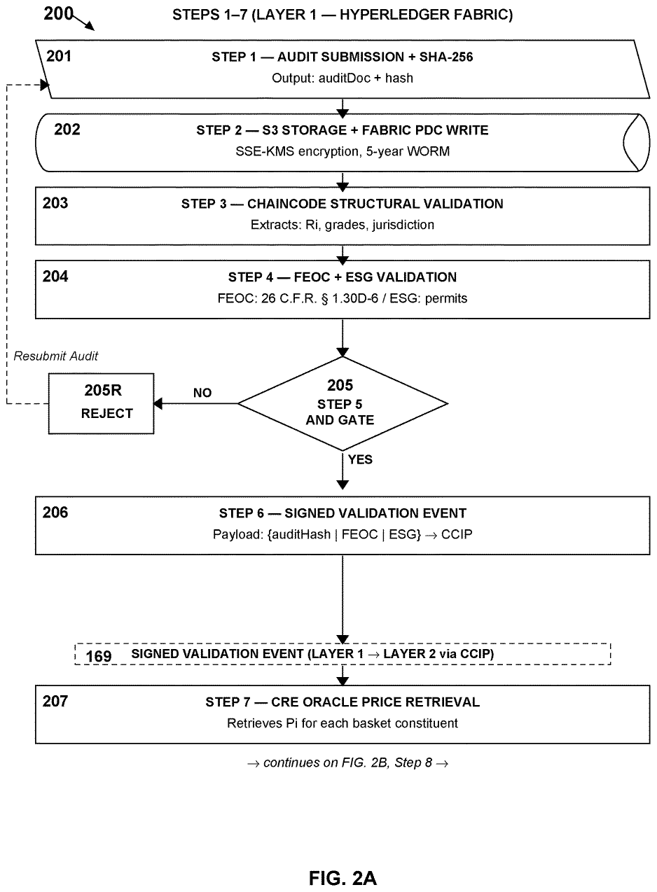

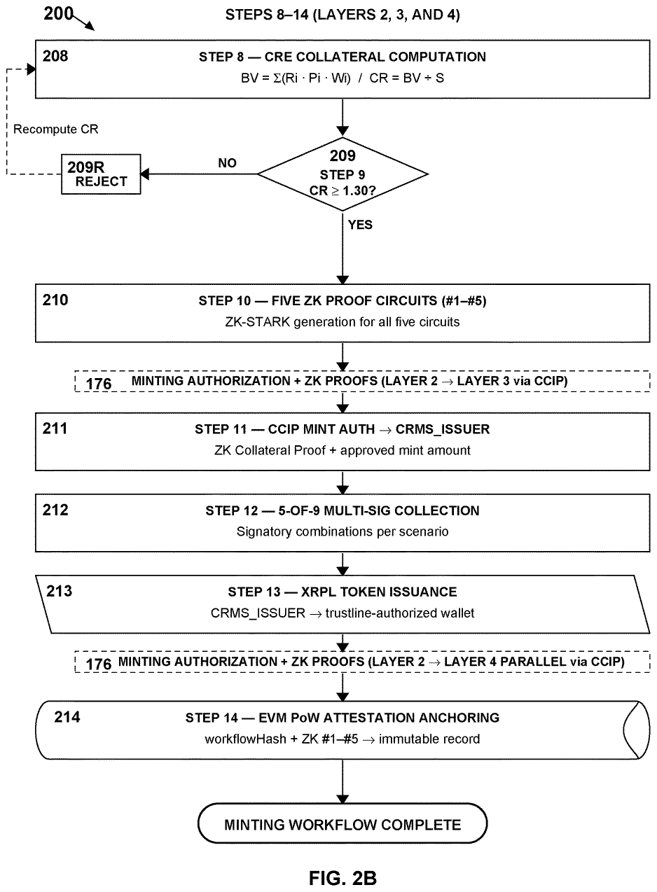

In at least one embodiment, FIGS. 2A and 2B together depict a fourteen-step minting and issuance workflow proceeding from audit submission at the first layer 110 (Steps 1 through 7) through basket valuation, zero-knowledge proof generation, and authoritative token issuance at the second layer 120 and the third layer 130 (Steps 8 through 13), with public attestation anchoring of workflow commitment hashes and proof outputs at the fourth layer 140 (Step 14).

### First Layer Permissioned Distributed Ledger Network

Referring to FIG. 1, the first layer 110, in at least one embodiment, comprises a permissioned distributed ledger network 160 implemented as a Hyperledger Fabric network, as disclosed in U.S. Provisional Patent Application No. 63/835,006 at element 102. The permissioned distributed ledger network 160, in at least one embodiment, comprises a plurality of peer nodes 161 operating under a crash-fault-tolerant Raft consensus protocol 167. Each peer node 161, in at least one embodiment, executes deterministic chaincode logic against committed transactions and writes endorsed transactions to a block-structured ledger replicated across the peer nodes 161.

In at least one embodiment, the permissioned distributed ledger network 160 maintains a plurality of segregated private data channels, including an Audit Channel 162 configured to receive geological reserve audit documents and yield audit documents from authorized participants, a Compliance Channel 163 configured to receive Foreign Entity of Concern attestations and Environmental Social and Governance compliance metadata, and a Sovereign Guarantee Channel 164 configured to receive sovereign mineral collateral declarations from authorized state sovereign representatives. In at least one embodiment, the Sovereign Guarantee Channel 164 is segregated from the Audit Channel 162 and from the Compliance Channel 163 such that data committed to any one of channels 162, 163, or 164 is not accessible to participants of the other channels. Such segregation, in at least one embodiment, preserves the commercial confidentiality of proprietary geological data while permitting cross-channel chaincode validation.

In at least one embodiment, upon receipt of an audit document, the permissioned distributed ledger network 160 computes a cryptographic hash of the audit document using a collision-resistant hash function (in at least one embodiment, a SHA-256 hash function, as disclosed in U.S. Provisional Patent Application No. 63/835,006 at element 108 and Claim 5), stores the audit document in a private data collection 174 of the permissioned distributed ledger network 160, and records only the cryptographic hash on the distributed ledger of the permissioned distributed ledger network 160. In at least one embodiment, the private data collection 174 is access-controlled by a Membership Service Provider 178 of the permissioned distributed ledger network 160.

In at least one embodiment, the permissioned distributed ledger network 160 executes chaincode logic comprising a Foreign Entity of Concern compliance chaincode gate 163-A operable to validate compliance with 26 C.F.R. § 1.30D-6, an Environmental Social and Governance compliance chaincode gate 163-B operable to validate Environmental Social and Governance metadata against defined standards, and an audit-standard compliance chaincode gate 165 operable to validate conformance of the audit document with one or more of NI 43-101, JORC, SGS, and equivalent standards. In at least one embodiment, the outputs of the chaincode gates 163-A, 163-B, and 165 are combined through an AND gate 168 such that a Signed Validation Event 169 is emitted by the permissioned distributed ledger network 160 only upon concurrent satisfaction of all three compliance conditions.

In at least one embodiment, the Signed Validation Event 169 comprises (i) the cryptographic hash of the audit document, (ii) an identifier of the audited mineral constituent and the audited jurisdiction of origin, (iii) an audit-validated reserve quantity, (iv) the Foreign Entity of Concern compliance status, (v) the Environmental Social and Governance compliance status, (vi) the audit-standard compliance status, and (vii) a digital signature of the permissioned distributed ledger network 160 generated using a private key managed by the Membership Service Provider 178. The Signed Validation Event 169, in at least one embodiment, is transmitted to the second layer 120 through a cross-chain interoperability protocol.

In at least one embodiment, the permissioned distributed ledger network 160 further maintains a Mineral Attribute Registry 177 storing structured metadata describing each audited mineral constituent, including without limitation mineral type, jurisdiction of origin, geological grade, recovery method, custody chain identifier, and audit-document reference hash. In at least one embodiment, the Mineral Attribute Registry 177 is read by the chaincode gates 163-A, 163-B, and 165 during validation and is updated only by transactions endorsed by a quorum of peer nodes 161.

### Second Layer Decentralized Oracle Computation and Cross-Chain Interoperability Protocol

Referring to FIG. 1, the second layer 120, in at least one embodiment, comprises a decentralized oracle computation network 171 communicatively coupled to a cross-chain interoperability protocol 175. In at least one embodiment, the decentralized oracle computation network 171 comprises a Chainlink Runtime Environment, and the cross-chain interoperability protocol 175 comprises a Chainlink Cross-Chain Interoperability Protocol. The second layer 120, in at least one embodiment, further comprises a Risk Management Network 190 operating in parallel to the cross-chain interoperability protocol 175 and configured to attest the validity and authenticity of each cross-chain message transported by the cross-chain interoperability protocol 175.

In at least one embodiment, the decentralized oracle computation network 171 retrieves commodity price data through an Oracle Price Aggregator 189 from a plurality of professional commodity pricing data feeds, in at least one embodiment, including without limitation Benchmark Mineral Intelligence, Fastmarkets, and S&P Global Commodity Insights. The Oracle Price Aggregator 189, in at least one embodiment, computes a time-weighted average of prices retrieved across the plurality of pricing data feeds and emits a consolidated oracle price for each constituent of a governance-weighted basket, as disclosed in U.S. Provisional Patent Application No. 63/835,006 at element 103.

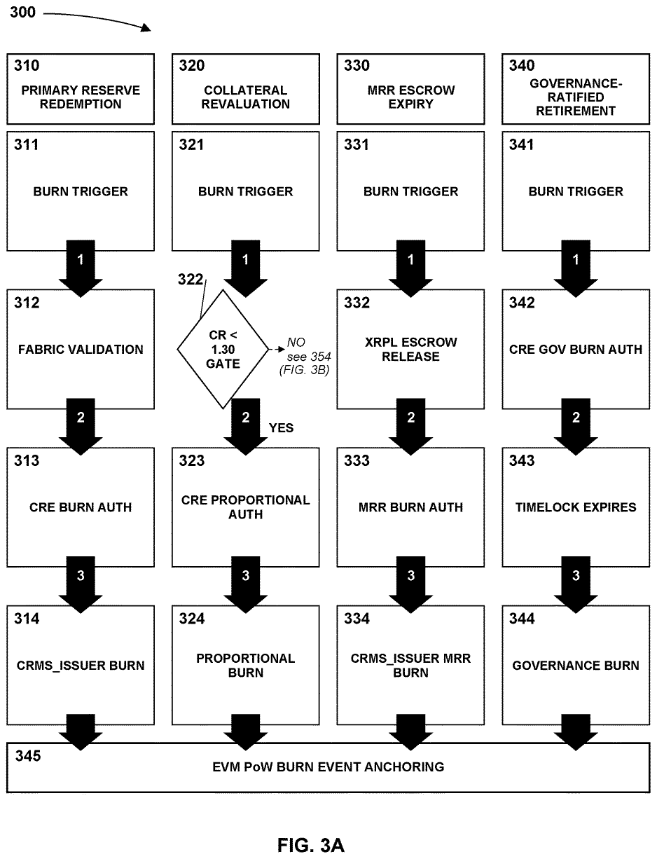

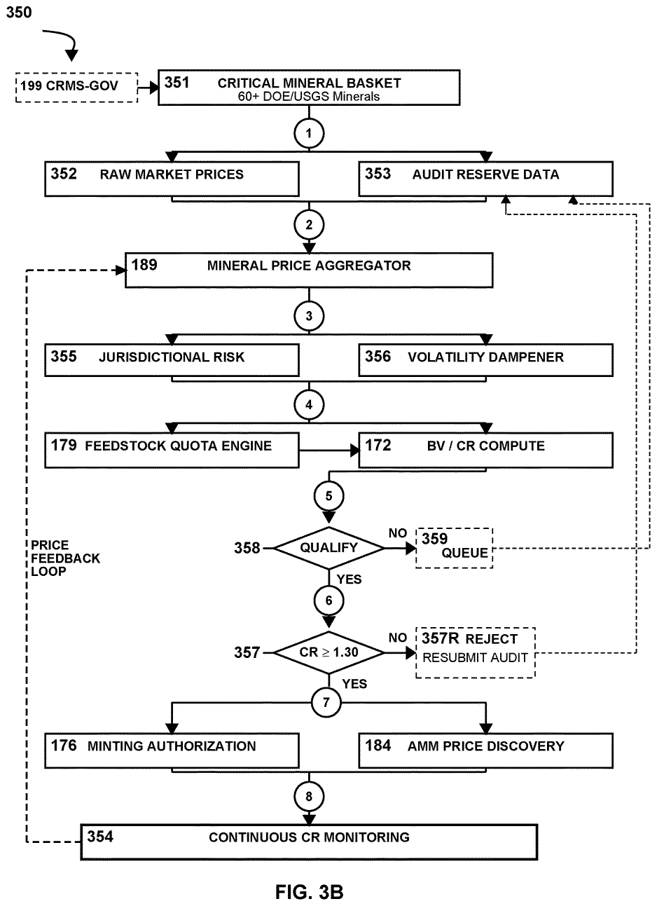

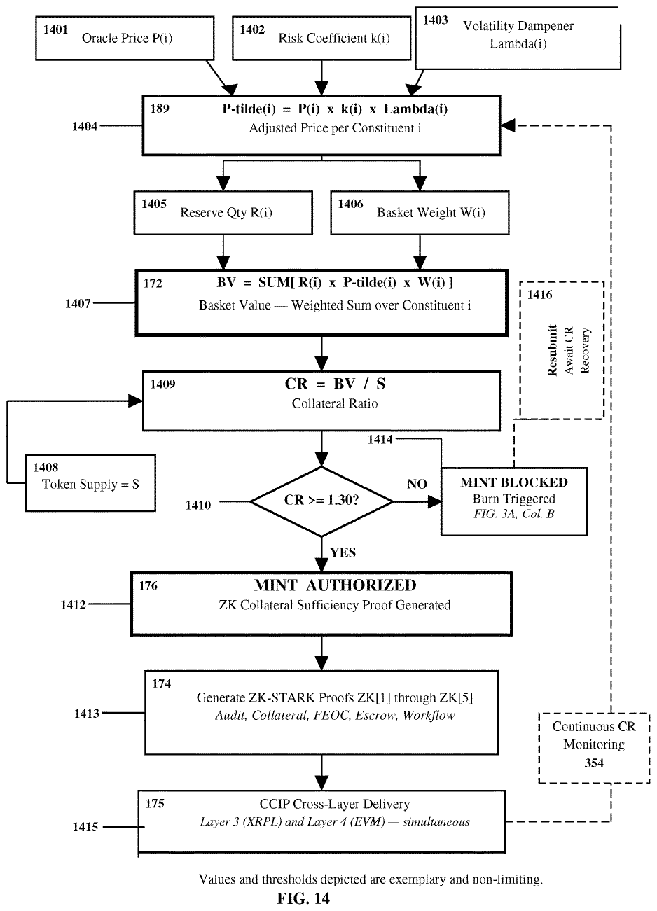

In at least one embodiment, the second layer 120 further comprises a Basket Value and Collateral Ratio Compute module 172 configured to receive the Signed Validation Event 169 from the first layer 110, retrieve the consolidated oracle prices from the Oracle Price Aggregator 189, retrieve governance-set basket allocation weights from the fourth layer 140, and compute a basket value and a collateral ratio according to a defined pricing function described in more detail with reference to FIGS. 3B and 14. The Basket Value and Collateral Ratio Compute module 172, in at least one embodiment, comprises a Collateral Ratio Gate 173 that blocks any minting authorization where the collateral ratio falls below a defined over-collateralization threshold.

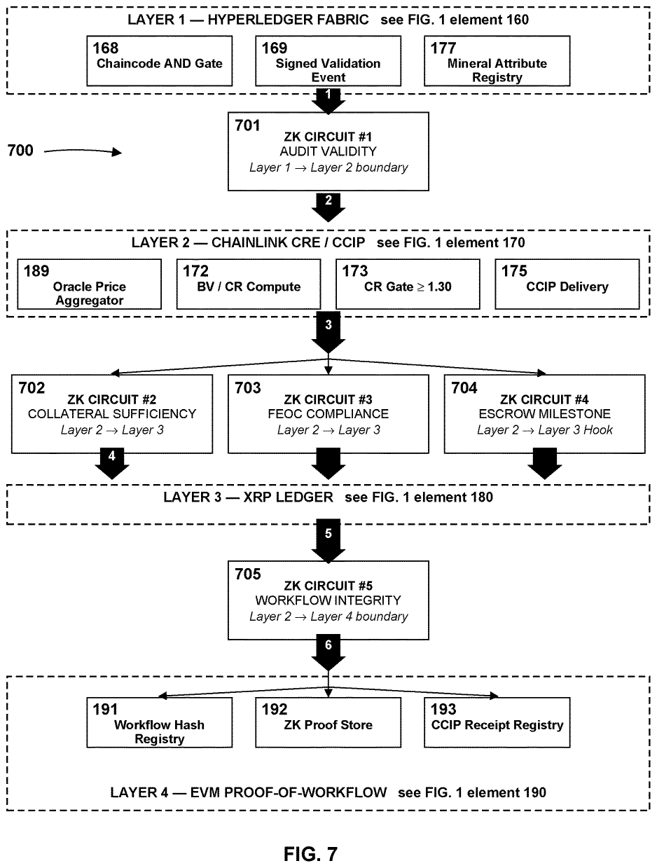

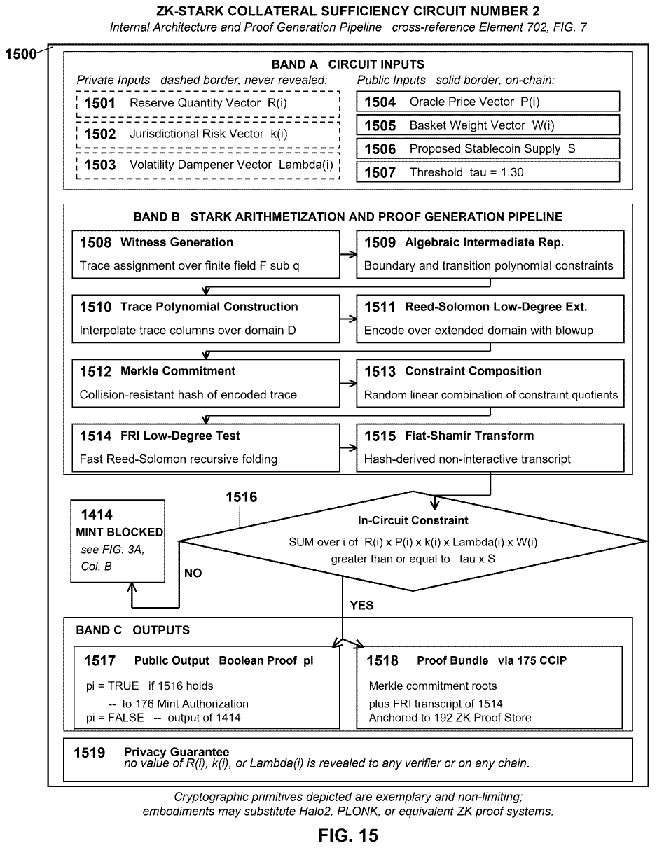

In at least one embodiment, upon a determination by the Collateral Ratio Gate 173 that the collateral ratio satisfies the over-collateralization threshold, the second layer 120 generates a zero-knowledge collateral sufficiency proof using a Collateral Sufficiency Circuit described in more detail with reference to FIGS. 7 and 15. In at least one embodiment, the second layer 120 transmits a minting authorization 176 to the third layer 130 through the cross-chain interoperability protocol 175, the minting authorization 176 comprising the zero-knowledge collateral sufficiency proof, an approved mint quantity, and a workflow commitment hash 174 binding the minting authorization 176 to the underlying Signed Validation Event 169.

In at least one embodiment, the decentralized oracle computation network 171 monitors the collateral ratio against oracle prices on a recurring basis, in at least one embodiment, at a polling interval defined by a governance parameter. In at least one embodiment, upon detection of a breach of the over-collateralization threshold, the decentralized oracle computation network 171 delivers a burn authorization through the cross-chain interoperability protocol 175 to the third layer 130, the burn authorization specifying a proportional stablecoin burn quantity computed to restore the collateral ratio to a defined target, as disclosed in U.S. Provisional Patent Application No. 63/835,006 at element 106.

Third Layer Permissioned Settlement Ledger with Credentialed Trustline Authorization

Referring to FIG. 1, the third layer 130, in at least one embodiment, comprises a permissioned settlement ledger 180 implemented as an XRP Ledger permissioned domain. The permissioned settlement ledger 180, in at least one embodiment, maintains a single authoritative issuer account 181 from which stablecoin token issuance, redemption, and burn operations are executed. In at least one embodiment, the authoritative issuer account 181 is controlled by a multi-signature governance threshold 184 requiring cryptographic signatures from a defined subset of authorized signatories drawn from a plurality of distinct supply chain participant classes.

In at least one embodiment, the permissioned settlement ledger 180 restricts token holding, receipt, and transfer to wallets having an active trustline authorization 182. The trustline authorization 182, in at least one embodiment, is granted to a candidate wallet only upon validation of the wallet holder's audit status and Foreign Entity of Concern compliance through the Membership Service Provider 178 of the first layer 110. In at least one embodiment, identity verification alone is insufficient to grant the trustline authorization 182; rather, the trustline authorization 182 is conditioned on a substantive geological audit standing or yield audit standing recorded on the Audit Channel 162 and a current Foreign Entity of Concern compliance record on the Compliance Channel 163. Upon detection of a change in audit status or Foreign Entity of Concern compliance, the trustline authorization 182, in at least one embodiment, is deactivated by the permissioned settlement ledger 180.

In at least one embodiment, the permissioned settlement ledger 180 receives the minting authorization 176 from the second layer 120 through the cross-chain interoperability protocol 175 and executes a token issuance operation by minting a quantity of stablecoin tokens equal to the approved mint quantity to a destination wallet having an active trustline authorization 182. In at least one embodiment, the permissioned settlement ledger 180 maintains a defined minimum over-collateralization ratio of 1.30 (corresponding to 130 percent over-collateralization), as disclosed in U.S. Provisional Patent Application No. 63/835,006 at element 104 and Claim 1(c), wherein each issued stablecoin token represents a fractional interest in the audit-validated reserve basket.

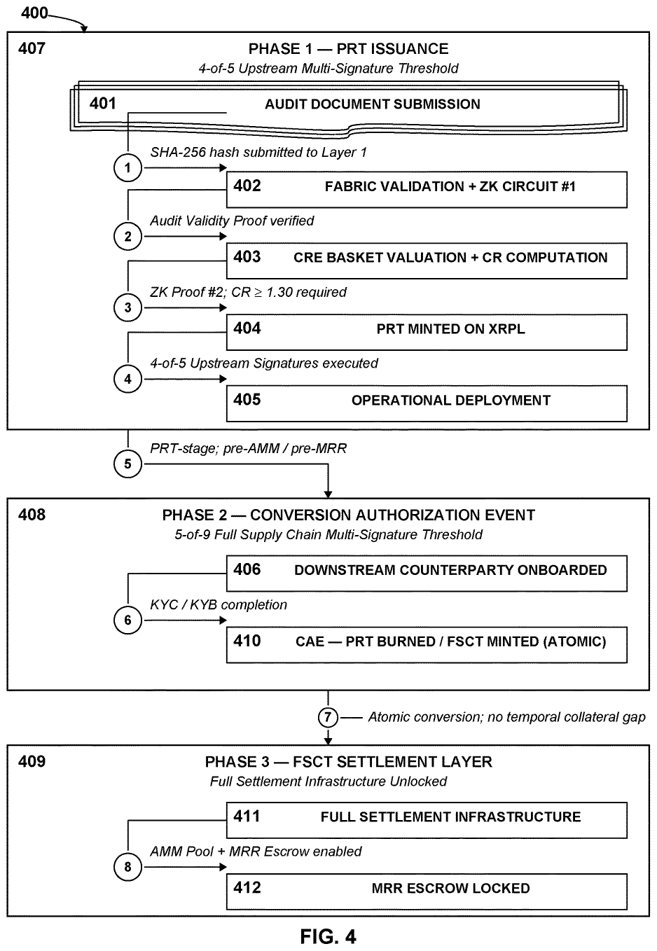

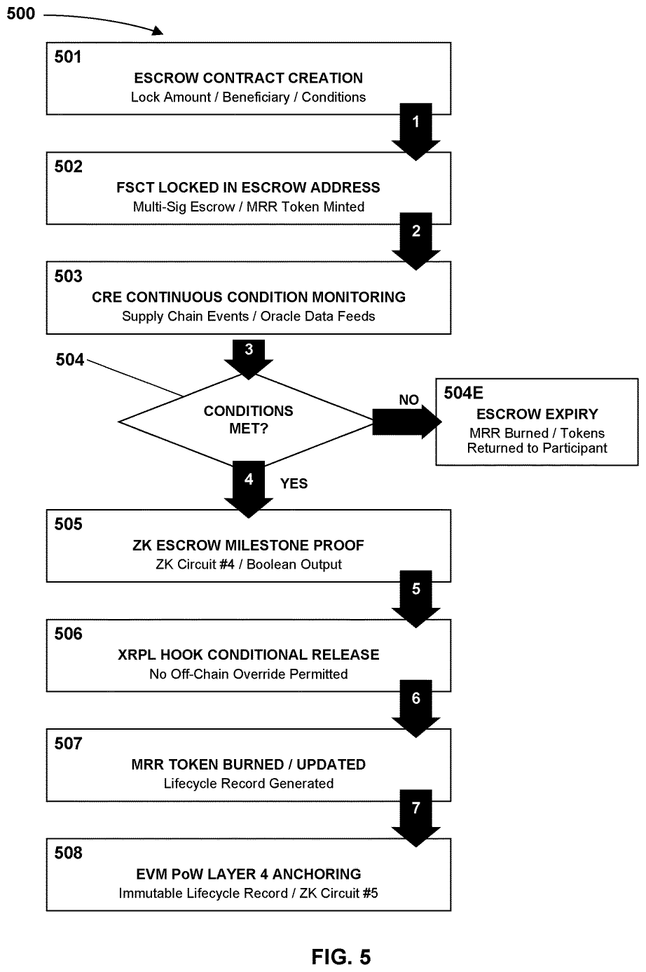

In at least one embodiment, the permissioned settlement ledger 180 further supports on-ledger hook-based conditional release logic 188 natively executed on the permissioned settlement ledger 180. In at least one embodiment, the hook-based conditional release logic 188 implements the Mineral Reserve Receipt programmable escrow described in more detail with reference to FIGS. 4 and 5. In at least one embodiment, the hook-based conditional release logic 188 is structurally incapable of releasing locked stablecoin by any pathway other than zero-knowledge-proof-conditioned cross-chain message delivery from the second layer 120 through the cross-chain interoperability protocol 175.

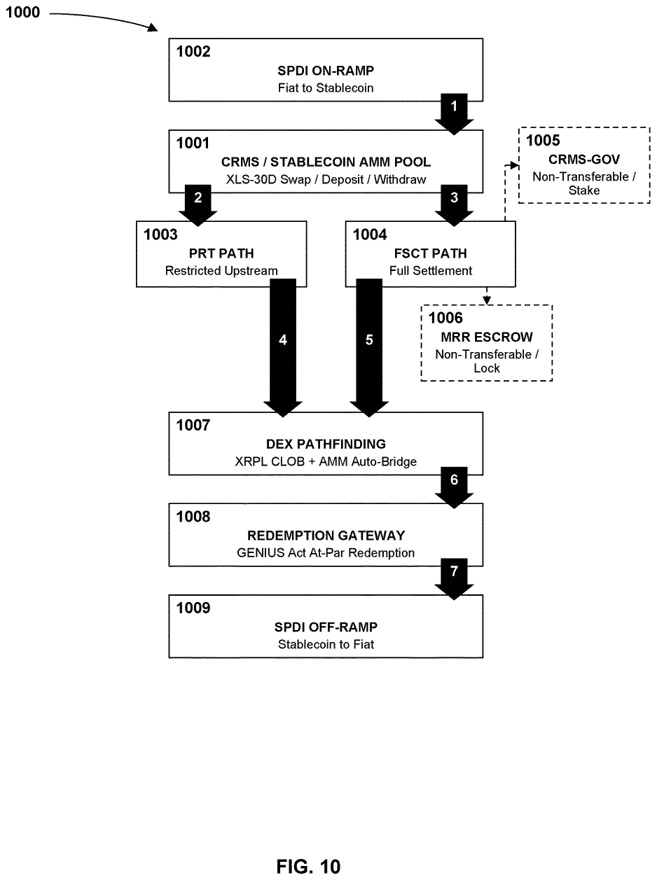

In at least one embodiment, the permissioned settlement ledger 180 further executes a redemption operation in which a holder of stablecoin tokens may exchange the tokens for an interest in the audit-validated physical mineral reserve through a redemption module verified by a third-party auditor, as disclosed in U.S. Provisional Patent Application No. 63/835,006 at element 107 and Claim 7. In at least one embodiment, the redemption operation is executed at par value through an at-par redemption gateway described in more detail with reference to FIG. 10.

### Fourth Layer Public Permissionless Attestation Contract

Referring to FIG. 1, the fourth layer 140, in at least one embodiment, comprises a public permissionless attestation contract deployed on a public blockchain. In at least one embodiment, the public blockchain comprises an Ethereum Virtual Machine-compatible blockchain, and the public permissionless attestation contract comprises a smart contract written in a language operable on the Ethereum Virtual Machine. The fourth layer 140, in at least one embodiment, further comprises a plurality of registries each anchored to the public permissionless attestation contract, comprising a Workflow Hash Registry 191, a Zero-Knowledge Proof Store 192, a Cross-Chain Interoperability Receipt Registry 193, and a Governance Commitment Registry 194.

In at least one embodiment, for each protocol operation executed by the architecture 100, a workflow commitment hash 174 corresponding to the protocol operation is immutably anchored on the Workflow Hash Registry 191, the outputs of any zero-knowledge proof generated by the second layer 120 in connection with the protocol operation are immutably anchored on the Zero-Knowledge Proof Store 192, the execution receipts of any cross-chain messages transported by the cross-chain interoperability protocol 175 in connection with the protocol operation are immutably anchored on the Cross-Chain Interoperability Receipt Registry 193, and the cryptographic commitment hashes of any governance votes associated with the protocol operation are immutably anchored on the Governance Commitment Registry 194.

In at least one embodiment, the public permissionless attestation contract exposes a publicly accessible cryptographic verification interface operable to permit any party, without requiring access to any private channel of the first layer 110, to verify the validity of an attested zero-knowledge proof against a stored Merkle commitment recorded on the Zero-Knowledge Proof Store 192.

### Three-Tier Sovereign Collateral Architecture

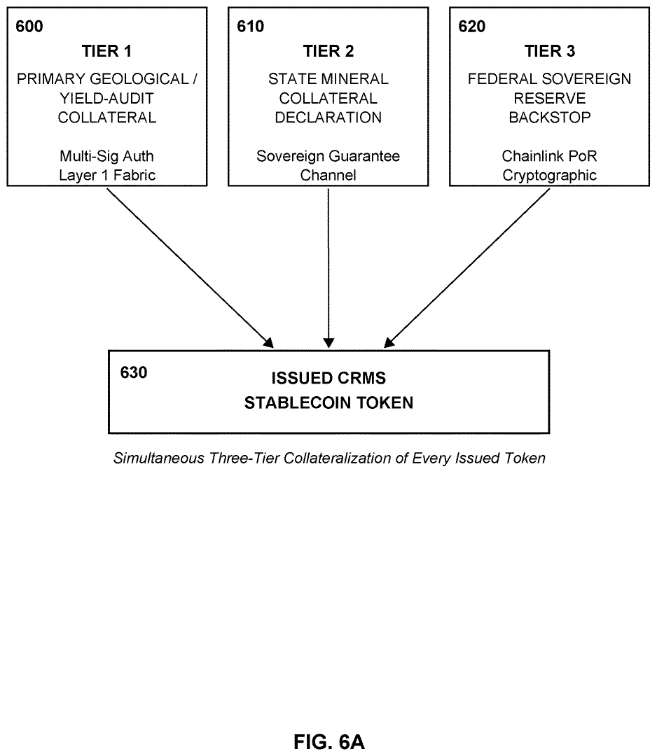

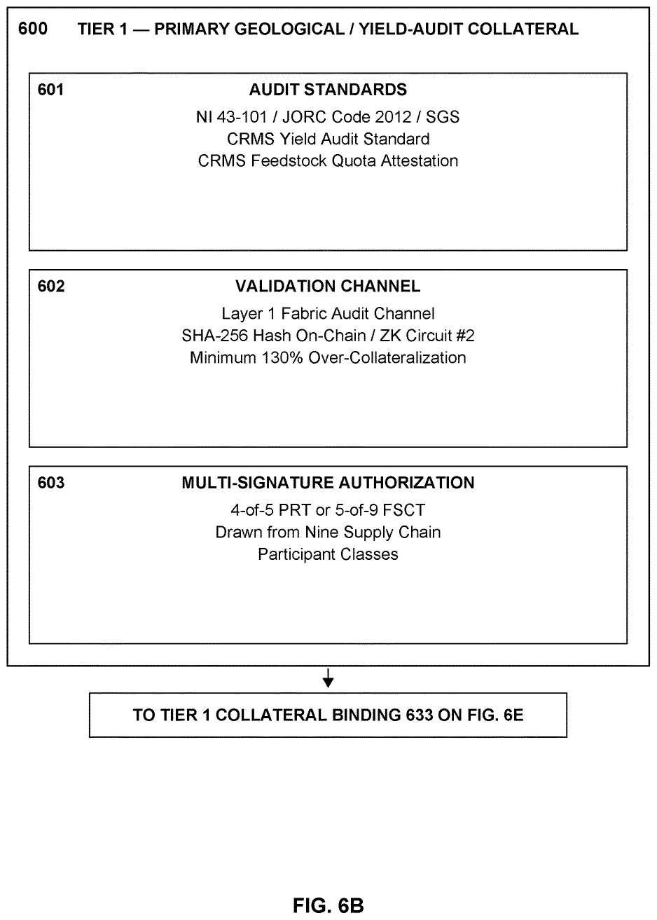

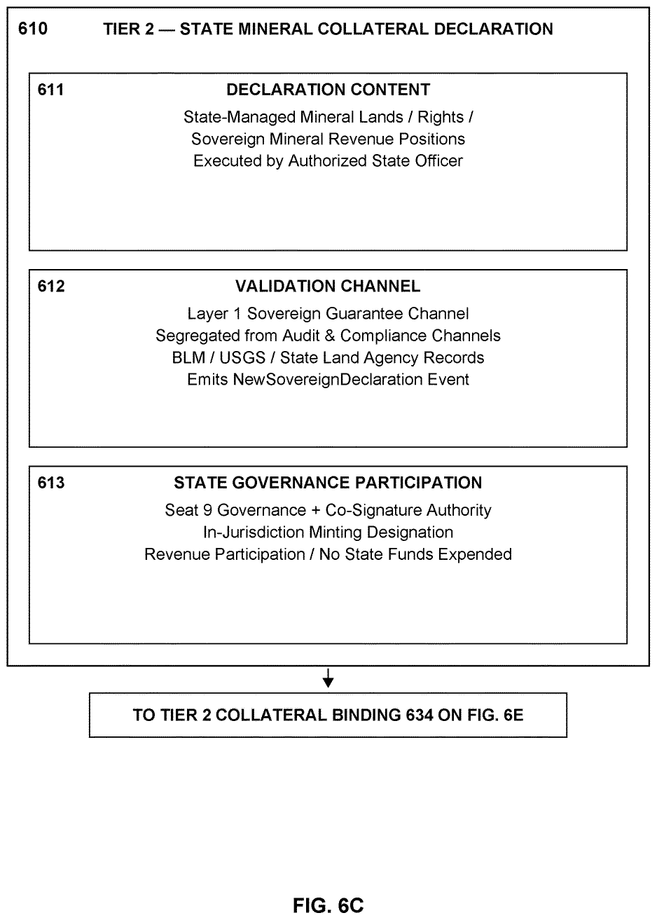

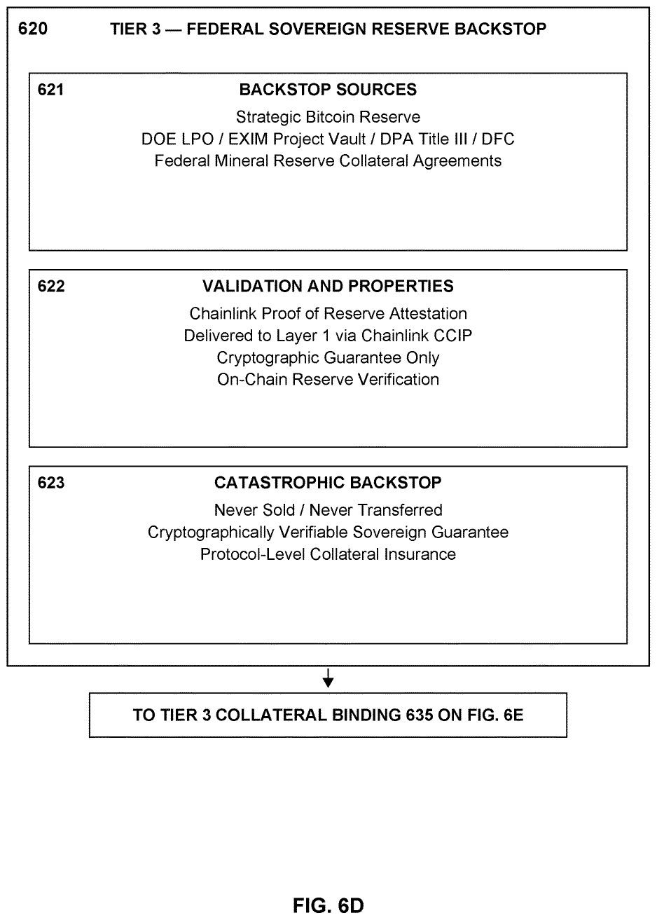

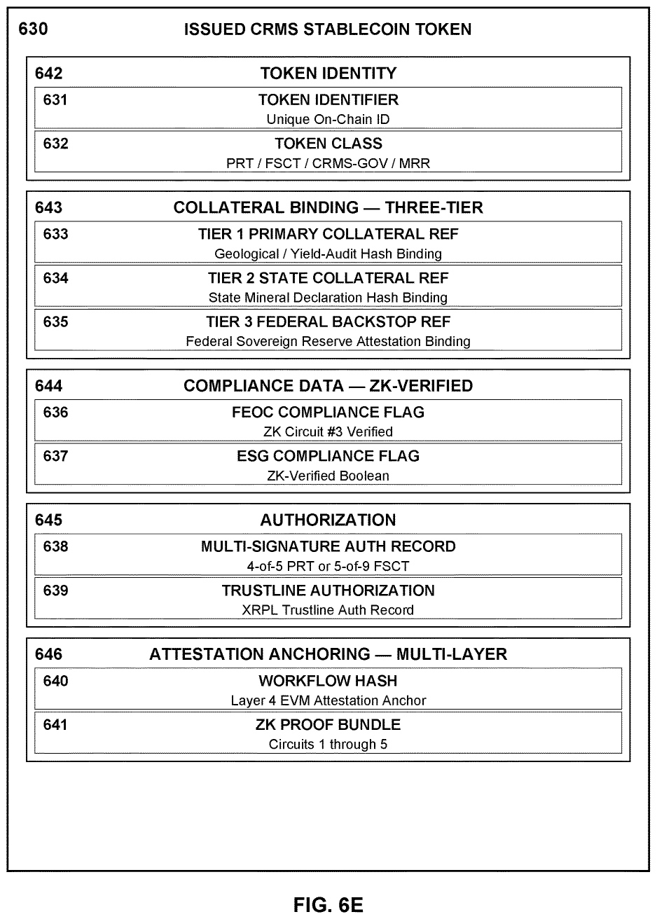

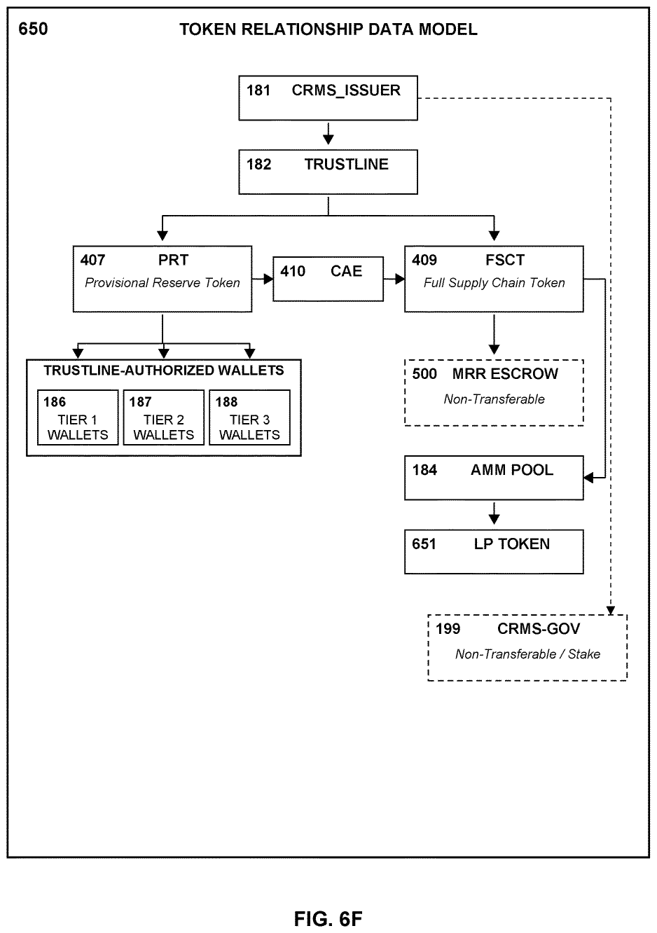

Referring to FIG. 6A, in at least one embodiment, every issued stablecoin token is simultaneously collateralized at three tiers, comprising a Tier 1 primary collateral position, a Tier 2 sovereign guarantee, and a Tier 3 federal sovereign reserve backstop. The three-tier collateral architecture, in at least one embodiment, provides redundant collateral support such that stablecoin holders are protected against transient impairment of any single collateral tier.

Referring to FIG. 6B, in at least one embodiment, the Tier 1 primary collateral position comprises an audit-validated physical mineral reserve position or yield position, selected from a geological reserve audit position and a yield audit position, validated through the first layer 110 at a defined minimum over-collateralization ratio. In at least one embodiment, the audit underlying the Tier 1 primary collateral position conforms to one or more of NI 43-101, JORC, and SGS standards and is committed to the Audit Channel 162 of the permissioned distributed ledger network 160.

Referring to FIG. 6C, in at least one embodiment, the Tier 2 sovereign guarantee comprises a sovereign mineral collateral declaration executed by an authorized state sovereign representative and committed to the Sovereign Guarantee Channel 164 of the permissioned distributed ledger network 160. In at least one embodiment, the Sovereign Guarantee Channel 164 is implemented as a permissioned private data channel segregated from each audit data channel 162 and each compliance data channel 163 of the first layer 110 and is configured to receive and validate sovereign mineral collateral declarations against state and federal land agency records without requiring submission of proprietary geological audit content.

Referring to FIG. 6D, in at least one embodiment, the Tier 3 federal sovereign reserve backstop comprises a federal sovereign reserve backstop designation cryptographically verified through an on-chain proof-of-reserve attestation anchored on the fourth layer 140. In at least one embodiment, the proof-of-reserve attestation comprises a cryptographic commitment computed over a register of reserve assets held in custody and is updated on a recurring basis by a designated sovereign-reserve custodian.

Referring to FIGS. 6E and 6F, in at least one embodiment, the issued stablecoin token is represented by a token data structure comprising a token identifier field, a three-tier collateral binding reference field, a zero-knowledge-verified compliance flag field, a multi-signature authorization record field, a trustline authorization record field, and a multi-layer attestation anchoring reference field. In at least one embodiment, the three-tier collateral binding reference field comprises a first reference to the Tier 1 primary collateral position recorded on the permissioned distributed ledger network 160, a second reference to the Tier 2 sovereign guarantee recorded through the Sovereign Guarantee Channel 164, and a third reference to the Tier 3 federal sovereign reserve backstop designation.

### Zero-Knowledge Proof Circuits and Inter-Layer Boundary Verification

Referring to FIG. 7, in at least one embodiment, the architecture 100 comprises a zero-knowledge proof architecture 700 implementing five zero-knowledge proof circuits each operating at a defined inter-layer boundary. In at least one embodiment, the five zero-knowledge proof circuits comprise a Collateral Sufficiency Circuit 701, a Foreign Entity of Concern Compliance Circuit 702, an Audit Standard Conformance Circuit 703, a Supply Chain Event Circuit 704, and a Governance Vote Eligibility Circuit 705.

Each zero-knowledge proof circuit, in at least one embodiment, comprises a prover module operable to generate a non-interactive proof transcript and a verifier module comprising a pre-compiled ZK-STARK verifier contract deployed on the fourth-layer attestation network. In at least one embodiment, each circuit implements a probability-based verification method through which the verifier becomes convinced of the truth of a statement-to-be-verified with overwhelming probability while learning nothing about the private inputs to the circuit.

FIG. 7 depicts the five zero-knowledge proof circuits 701, 702, 703, 704, and 705 of the zero-knowledge proof architecture 700 in the context of their respective inter-layer boundaries. The Layer 1 elements (Signed Validation Event 169, Peer Nodes 161, Chaincode Gates 163, 164, 165, AND Gate 168, Mineral Attribute Registry 177) and Layer 2 elements (Oracle Price Aggregator 189, Basket Value and Collateral Ratio Compute module 172, Collateral Ratio Gate 173, cross-chain interoperability protocol 175) and Layer 4 elements (Workflow Hash Registry 191, Zero-Knowledge Proof Store 192, Cross-Chain Interoperability Receipt Registry 193) depicted as boundary-adjacent context in FIG. 7 are the same elements as depicted in FIG. 1 and are shown in FIG. 7 solely to illustrate the layer-boundary location of each zero-knowledge proof circuit. No new reference numerals are introduced by FIG. 7.

In at least one embodiment, the Collateral Sufficiency Circuit 701 operates at a boundary between the second layer 120 and the third layer 130. Private inputs to the Collateral Sufficiency Circuit 701, in at least one embodiment, comprise reserve quantities Rᵢ for each mineral constituent i in the governance-weighted basket, jurisdictional risk coefficients kᵢ, and volatility dampeners λᵢ. Public inputs to the Collateral Sufficiency Circuit 701, in at least one embodiment, comprise oracle prices Pᵢ retrieved from the Oracle Price Aggregator 189, governance-set basket allocation weights Wᵢ, and a proposed stablecoin supply quantity S. The statement-to-be-verified by the Collateral Sufficiency Circuit 701, in at least one embodiment, is the statement that the collateral ratio CR=Σᵢ(Rᵢ·Pᵢ·kᵢ·λᵢ·Wᵢ)÷S satisfies a defined over-collateralization threshold τ. The public output of the Collateral Sufficiency Circuit 701, in at least one embodiment, is a Boolean proof π attesting that CR≥τ without revealing Rᵢ, kᵢ, or λᵢ.

In at least one embodiment, the Foreign Entity of Concern Compliance Circuit 702 operates at a boundary between the first layer 110 and the second layer 120. Private inputs to the Foreign Entity of Concern Compliance Circuit 702, in at least one embodiment, comprise Foreign Entity of Concern attestation metadata for each upstream participant in the custody chain of the underlying audit document. Public inputs to the Foreign Entity of Concern Compliance Circuit 702, in at least one embodiment, comprise a Foreign Entity of Concern threshold parameter and a regulatory reference identifier. The statement-to-be-verified by the Foreign Entity of Concern Compliance Circuit 702, in at least one embodiment, is the statement that no upstream participant in the custody chain is a Foreign Entity of Concern under 26 C.F.R. §1.30D-6. The public output of the Foreign Entity of Concern Compliance Circuit 702 is a Boolean proof attesting to the foregoing statement without revealing the identities of upstream participants.

In at least one embodiment, the Audit Standard Conformance Circuit 703 operates at a boundary between the first layer 110 and the second layer 120. Private inputs to the Audit Standard Conformance Circuit 703, in at least one embodiment, comprise structured fields extracted from the audit document, including without limitation reserve estimation methodology, qualified person identifier, audit date, and audited mineral grade. Public inputs to the Audit Standard Conformance Circuit 703, in at least one embodiment, comprise a designated audit standard identifier (in at least one embodiment, NI 43-101, JORC, or SGS) and a minimum date of audit currency. The statement-to-be-verified by the Audit Standard Conformance Circuit 703, in at least one embodiment, is the statement that the audit document conforms to the designated audit standard and is dated no earlier than the minimum date of audit currency. The public output is a Boolean proof attesting to conformance without revealing proprietary audit content.

In at least one embodiment, the Supply Chain Event Circuit 704 operates at a boundary between the second layer 120 and the third layer 130 and provides a zero-knowledge proof of satisfaction of one or more verifiable supply chain milestone events. Private inputs to the Supply Chain Event Circuit 704, in at least one embodiment, comprise documentary evidence of a supply chain milestone (in at least one embodiment, a bill of lading, a shipment manifest, an assay-confirmed delivery receipt, or a milestone attestation under a contract executed pursuant to Title III of the Defense Production Act). Public inputs comprise a defined milestone-event specification. The statement-to-be-verified is the statement that the documentary evidence satisfies the defined milestone-event specification. The public output is a Boolean escrow milestone proof, in at least one embodiment, consumed by the Mineral Reserve Receipt programmable escrow described elsewhere herein.

In at least one embodiment, the Governance Vote Eligibility Circuit 705 operates at a boundary between the first layer 110 and the second layer 120 and supports zero-knowledge-private governance voting. Private inputs to the Governance Vote Eligibility Circuit 705, in at least one embodiment, comprise the voting participant's on-ledger geological reserve collateral position recorded on the permissioned distributed ledger network 160. Public inputs comprise a defined eligibility threshold and a governance proposal identifier. The statement-to-be-verified, in at least one embodiment, is the statement that the voting participant's on-ledger reserve collateral position equals or exceeds the eligibility threshold for the identified governance proposal. The public output is a Boolean proof attesting eligibility without revealing the magnitude of the voting participant's reserve collateral position. In at least one embodiment, voting weight is derived from the participant's verified geological reserve collateral position rather than from a token-price-determined investment amount.

FIG. 15 depicts an internal architecture and proof generation pipeline 1500 of the Collateral Sufficiency Circuit 701 in accordance with at least one embodiment. Referring to FIG. 15, the proof generation pipeline 1500 comprises, in at least one embodiment, a Witness Generation stage 1508, an Algebraic Intermediate Representation stage 1509, a Trace Polynomial Construction stage 1510, a Reed-Solomon Low-Degree Extension stage 1511, a Merkle Commitment stage 1512, a Constraint Composition stage 1513, a FRI Low-Degree Test stage 1514, and a Fiat-Shamir Transform stage 1515. The Witness Generation stage 1508, in at least one embodiment, assigns private inputs as values in a finite field Fₚ. The Algebraic Intermediate Representation stage 1509, in at least one embodiment, encodes boundary constraints and transition constraints over the assigned values. The Trace Polynomial Construction stage 1510, in at least one embodiment, interpolates trace columns over a domain D. The Reed-Solomon Low-Degree Extension stage 1511, in at least one embodiment, encodes the trace polynomial over an extended domain with a defined blowup factor. The Merkle Commitment stage 1512, in at least one embodiment, computes a Merkle commitment to the encoded trace using a collision-resistant hash function. The Constraint Composition stage 1513, in at least one embodiment, computes a random linear combination of constraint quotients. The FRI Low-Degree Test stage 1514, in at least one embodiment, implements fast Reed-Solomon recursive folding. The Fiat-Shamir Transform stage 1515, in at least one embodiment, derives a hash-based non-interactive proof transcript.

In at least one embodiment, the non-interactive proof transcript produced by each zero-knowledge proof circuit is bound to the workflow commitment hash 174 and to the originating audit hash, configured to prevent replay attacks wherein a previously generated proof transcript is reused in a subsequent and unrelated transaction context. In at least one embodiment, the workflow commitment hash 174 is constructed by applying a collision-resistant hash function to a concatenation of the originating audit hash, an identifier of the requesting participant, an identifier of the destination wallet, and a current epoch nonce.

Although certain embodiments are described herein with reference to ZK-STARK proof systems, in at least one embodiment any one or more of the zero-knowledge proof circuits 701, 702, 703, 704, and 705 may equivalently be implemented using Halo2, PLONK, Groth16, or any other zero-knowledge proof system providing non-interactive verification, soundness, and zero-knowledge against a computationally bounded verifier. The cryptographic primitives depicted in any figure are exemplary and non-limiting.

### Mineral Reserve Receipt Programmable Escrow

Referring to FIGS. 4 and 5, the architecture 100, in at least one embodiment, further comprises a Mineral Reserve Receipt programmable escrow subsystem 500 integrated within the third layer 130. The Mineral Reserve Receipt programmable escrow subsystem 500, in at least one embodiment, comprises a Mineral Reserve Receipt token representing a quantity of stablecoin held in a multi-signature escrow address, on-ledger conditional release logic 188 implemented as hook-based smart logic natively executed on the permissioned settlement ledger 180, and an immutable Mineral Reserve Receipt lifecycle record anchored on the fourth layer 140.

In at least one embodiment, the multi-signature escrow address requires authorization from at least three independent parties to release locked stablecoin: (i) the second layer 120, in the form of a cryptographically authenticated protocol authorization signal delivered through the cross-chain interoperability protocol 175 and accompanied by a valid zero-knowledge escrow milestone proof generated by the Supply Chain Event Circuit 704; (ii) an initiating participant holding a first-layer-issued identity credential; and (iii) a designated beneficiary holding a first-layer-issued identity credential. In at least one embodiment, the on-ledger conditional release logic 188 is structurally incapable of releasing the locked stablecoin by any pathway other than zero-knowledge-proof-conditioned cross-chain message delivery from the second layer 120; that is, there exists no bilateral off-chain release mechanism, no manual override pathway, and no administrative escape hatch by which the locked stablecoin may be released absent receipt of a valid zero-knowledge escrow milestone proof.

Referring to FIG. 5, the lifecycle of the Mineral Reserve Receipt programmable escrow subsystem 500, in at least one embodiment, progresses through contract creation, oracle-monitored condition evaluation by the decentralized oracle computation network 171, zero-knowledge milestone proof generation by the Supply Chain Event Circuit 704, hook-based conditional release by the on-ledger conditional release logic 188, and anchoring of a complete escrow lifecycle record on the fourth layer 140. In at least one embodiment, the complete escrow lifecycle record comprises cryptographic hashes of an escrow creation event, each condition monitoring event, and a release or expiry event, together with corresponding zero-knowledge proof outputs.

Referring to FIG. 4, in at least one embodiment, the Mineral Reserve Receipt programmable escrow subsystem 500 is integrated with a tiered minting lifecycle comprising a Provisional Reserve Token issuance phase, an atomic Conversion Authorization Event, and a Full Supply Chain Token issuance phase. In at least one embodiment, a Provisional Reserve Token is issued upon initial audit validation; the Provisional Reserve Token is converted to a Full Supply Chain Token through an atomic Conversion Authorization Event upon satisfaction of a defined set of supply chain milestone events verified by the Supply Chain Event Circuit 704. In at least one embodiment, the Mineral Reserve Receipt programmable escrow subsystem 500 supports defense procurement embodiments in which the defined set of supply chain milestone events comprises contract-performance milestones encoded as on-ledger programmable escrow release conditions, including without limitation milestones defined under Title III of the Defense Production Act.

### Basket Valuation, Risk-Adjusted Pricing, and Collateral Ratio Computation

Referring to FIGS. 3B and 14, in at least one embodiment, the Basket Value and Collateral Ratio Compute module 172 of the second layer 120 computes a basket value and a collateral ratio according to a defined pricing function. In at least one embodiment, for each critical mineral constituent i in the governance-weighted basket, the Basket Value and Collateral Ratio Compute module 172 computes an adjusted price \tilde{P}ᵢ according to the relation \tilde{P}ᵢ=Pᵢ·kᵢ·λᵢ, wherein Pᵢ is a real-time commodity price retrieved from the Oracle Price Aggregator 189, kᵢ is a jurisdictional risk coefficient specific to a verified jurisdiction of origin recorded in the audit document, and λᵢ is a volatility dampener that reduces the effective price input during periods of elevated commodity price volatility.

In at least one embodiment, the Basket Value and Collateral Ratio Compute module 172 computes the basket value BV according to the relation BV=Σᵢ(Rᵢ·\tilde{P}ᵢ·Wᵢ), wherein Rᵢ is the audit-validated reserve quantity for constituent i and Wᵢ is the governance-set allocation weight for constituent i. In at least one embodiment, the governance-set allocation weights Wᵢ are set by participant-class-weighted governance vote and may be updated periodically through a governance vote ratified by a multi-signature governance threshold 184.

In at least one embodiment, the Basket Value and Collateral Ratio Compute module 172 computes the collateral ratio CR according to the relation CR=BV÷S, wherein S is the proposed stablecoin supply quantity. In at least one embodiment, the Collateral Ratio Gate 173 blocks any minting authorization 176 unless CR satisfies a defined over-collateralization threshold τ. In at least one embodiment, τ=1.30. Specific values of τ and any specific functional relationships depicted in the foregoing equations are exemplary and non-limiting.

### Stablecoin Token Data Structure and Compliance Flag Field

Referring to FIGS. 6E and 6F, in at least one embodiment, the permissioned settlement ledger 180 instantiates and maintains a stablecoin token data structure 600 comprising a token identifier field 601, a three-tier collateral binding reference field 602, a zero-knowledge-verified compliance flag field 603, a multi-signature authorization record field 604, a trustline authorization record field 605, and a multi-layer attestation anchoring reference field 606.

In at least one embodiment, the zero-knowledge-verified compliance flag field 603 comprises at least three flags, including a Foreign Entity of Concern compliance flag, an Environmental Social and Governance compliance flag, and an audit compliance flag. In at least one embodiment, each flag is settable only upon successful execution of a corresponding zero-knowledge proof circuit operating at a defined inter-layer boundary as described in connection with FIG. 7. In at least one embodiment, the trustline authorization record field 605 further comprises a credential identifier referencing an identity credential of the wallet holder issued by the Membership Service Provider 178 of the first layer 110, an audit status validation timestamp, and a Foreign Entity of Concern compliance validation timestamp.

In at least one embodiment, upon detection by the Membership Service Provider 178 of a change in audit status or Foreign Entity of Concern compliance associated with the credential identifier, the permissioned settlement ledger 180 deactivates the trustline authorization record field 605 of any token held by the affected wallet holder, with the result that the affected wallet holder is blocked from further token receipt or transfer pending revalidation.

### Multi-Class Governance, Participant Classes, and Cross-Layer Execution

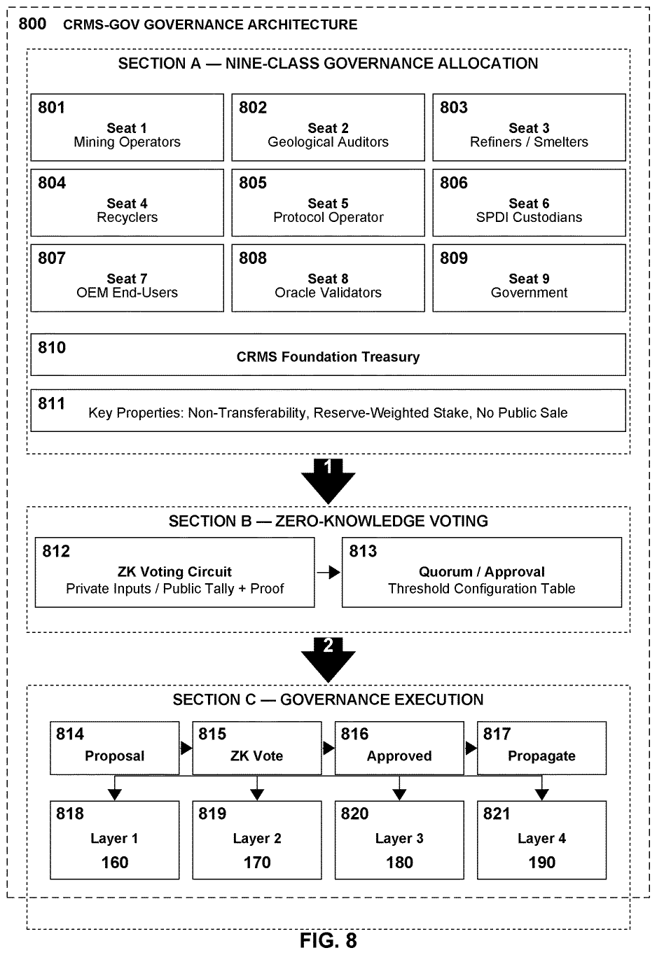

Referring to FIG. 8, in at least one embodiment, the architecture 100 further comprises a multi-class governance token architecture operating across the four-layer hybrid blockchain architecture. In at least one embodiment, the multi-class governance token architecture comprises a non-transferable governance stake represented as a cross-layer governance channel 199 maintained across the first layer 110, the second layer 120, the third layer 130, and the fourth layer 140. The cross-layer governance channel 199 of the present embodiments corresponds to the same underlying governance token system depicted as element 1005 in FIG. 10 and described in U.S. Provisional Patent Application No. 64/056,244; the differing reference numerals reflect distinct functional aspects of the same underlying governance token system.

In at least one embodiment, the plurality of distinct supply chain participant classes from which the multi-signature governance threshold 184 is drawn comprises at least nine classes, including (i) mining operators, (ii) geological auditors, (iii) refiners and smelters as a domestic-refining and smelting class distinct from (iv) recyclers and secondary processors as a domestic-recycling and secondary-processing class, (v) original equipment manufacturer end-users, (vi) special purpose depository institution custodians, (vii) oracle and infrastructure validators, (viii) government and sovereign representatives, and (ix) a protocol foundation entity. In at least one embodiment, the multi-signature governance threshold 184 requires cryptographic signatures from a quorum of authorized signatories drawn from at least five distinct classes of the nine classes for a token issuance operation to be executed by the authoritative issuer account 181.

In at least one embodiment, the multi-class governance token architecture supports zero-knowledge-private governance voting implemented through the Governance Vote Eligibility Circuit 705, wherein the voting weight of each participant is derived from the participant's verified geological reserve collateral position recorded on the permissioned distributed ledger network 160 rather than from market-determined token price or financial investment amount.

### Additional Subsystems, Document Intelligence, and Secondary Reserve Flow

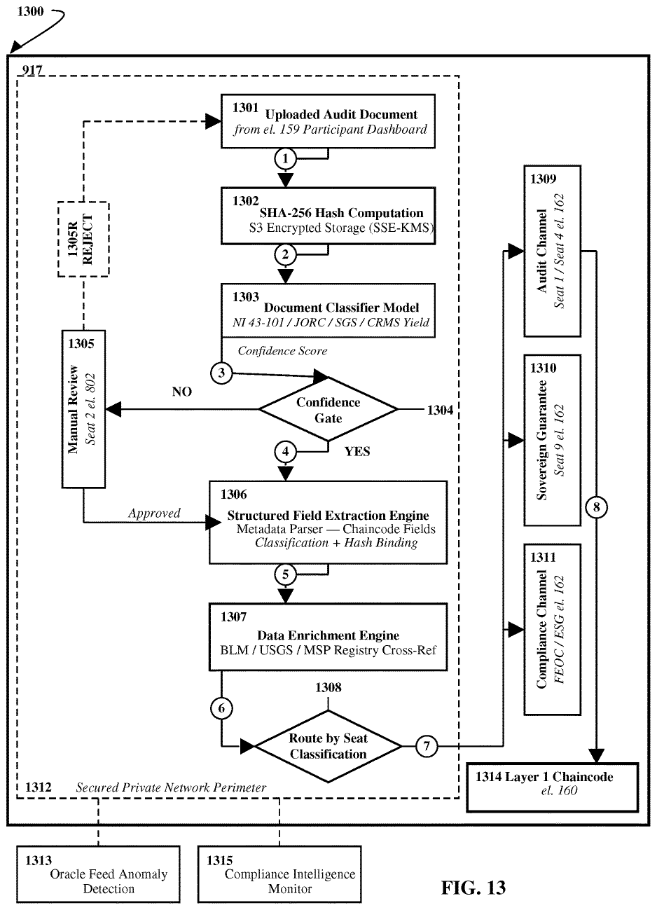

Referring to FIG. 13, in at least one embodiment, the architecture 100 further comprises a Mineral Audit Intelligence Engine deployed between a participant access interface and the first layer 110. In at least one embodiment, the Mineral Audit Intelligence Engine operates exclusively in a pre-validation domain and is configured to perform participant-class-aware document classification, structured field extraction from documents conforming to one or more of NI 43-101, JORC, SGS, Feedstock Quota Attestation, and State Mineral Collateral Declaration formats, and routing of extracted metadata to the Audit Channel 162, the Sovereign Guarantee Channel 164, or the Compliance Channel 163 of the first layer 110. In at least one embodiment, the Mineral Audit Intelligence Engine is structurally without authority over zero-knowledge proof generation, multi-signature authorization, collateral ratio computation, or settlement execution; that is, the Mineral Audit Intelligence Engine cannot independently authorize any token issuance, redemption, or burn operation.

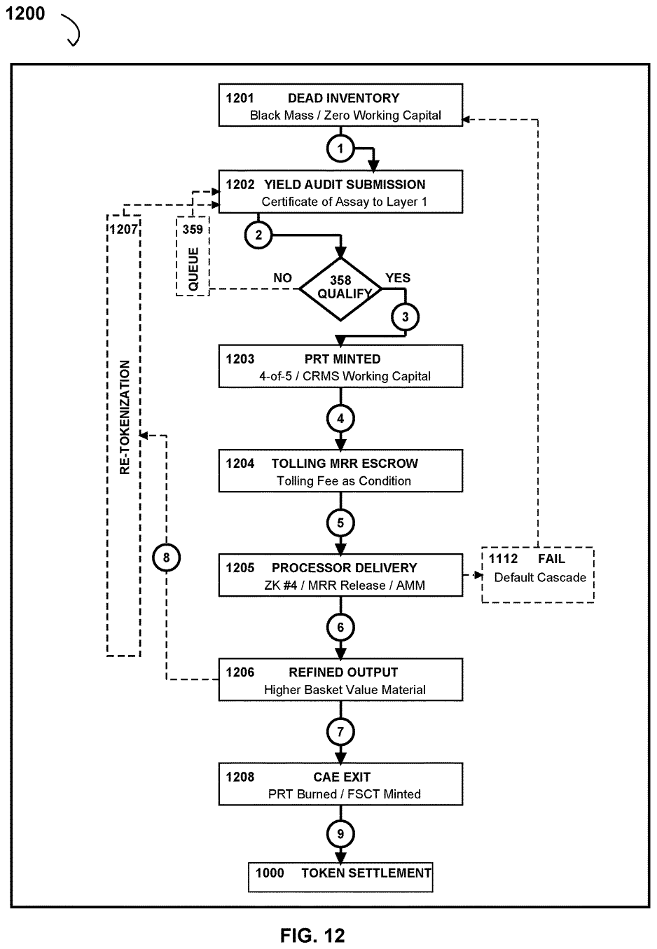

Referring to FIG. 12, in at least one embodiment, the architecture 100 further supports a secondary reserve flow comprising a recycler re-tokenization cycle by which secondary recovered mineral material progresses from dead inventory through yield audit submission, Provisional Reserve Token minting, programmable tolling escrow, processor delivery verification, refined output receipt, a re-tokenization loop, and Conversion Authorization Event exit. In at least one embodiment, the recycler re-tokenization cycle utilizes the same Mineral Reserve Receipt programmable escrow subsystem 500 and the same Supply Chain Event Circuit 704 described elsewhere herein.

Referring to FIG. 10, in at least one embodiment, the architecture 100 further supports token trading and settlement through a fiat on-ramp implemented through a state-chartered Special Purpose Depository Institution, an automated market maker pool, restricted and unrestricted token transfer paths, an exchange pathfinding engine, an at-par redemption gateway, and a fiat off-ramp. In at least one embodiment, the at-par redemption gateway permits exchange of a stablecoin token at par value, in accordance with applicable regulatory frameworks.

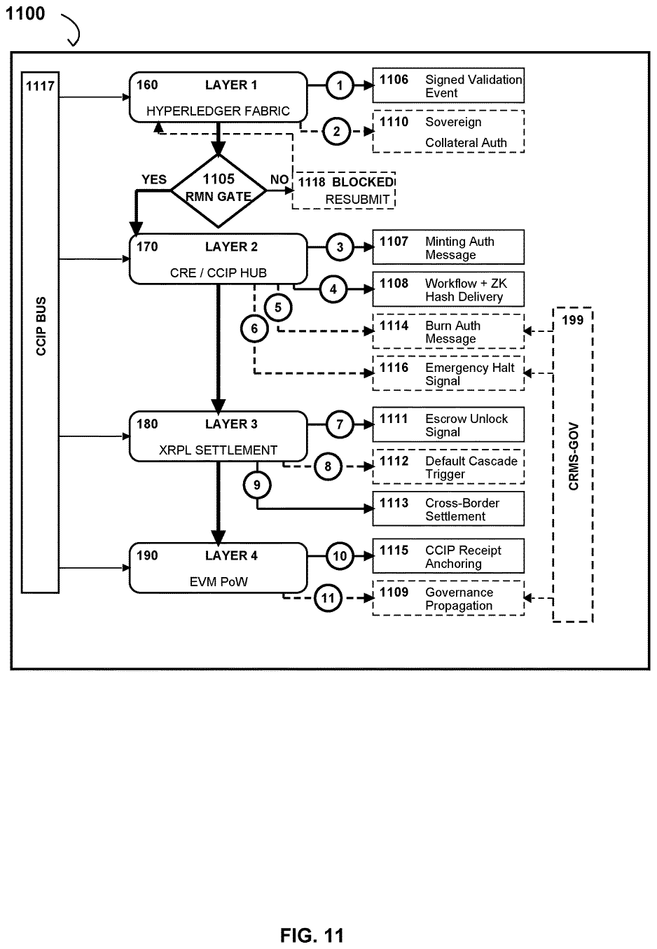

Referring to FIG. 11, in at least one embodiment, the cross-chain interoperability protocol 175 transports a plurality of distinct message types across the four-layer hybrid blockchain architecture, including without limitation a minting-authorization message, a burn-authorization message, an escrow-creation message, an escrow-milestone-proof message, an escrow-release message, an escrow-expiry message, a trustline-revocation message, a governance-ratification message, a sovereign-collateral-update message, an attestation-anchor message, and a Risk Management Network validation-confirmation message. In at least one embodiment, each cross-chain message is validated by the Risk Management Network 190 prior to delivery to the destination layer.

Referring to FIG. 3A, in at least one embodiment, the architecture 100 supports four parallel burn-mechanism scenarios under which stablecoin tokens are reduced in circulation, comprising primary reserve redemption, downward collateral revaluation, programmable escrow expiry, and governance-ratified token retirement. In at least one embodiment, the architecture 100 further supports a default cascade mechanism and an emergency halt mechanism by which token issuance is suspended and active collateral positions are reassessed upon governance ratification.

### Computer Systems, Cloud Infrastructure, and Alternative Embodiments

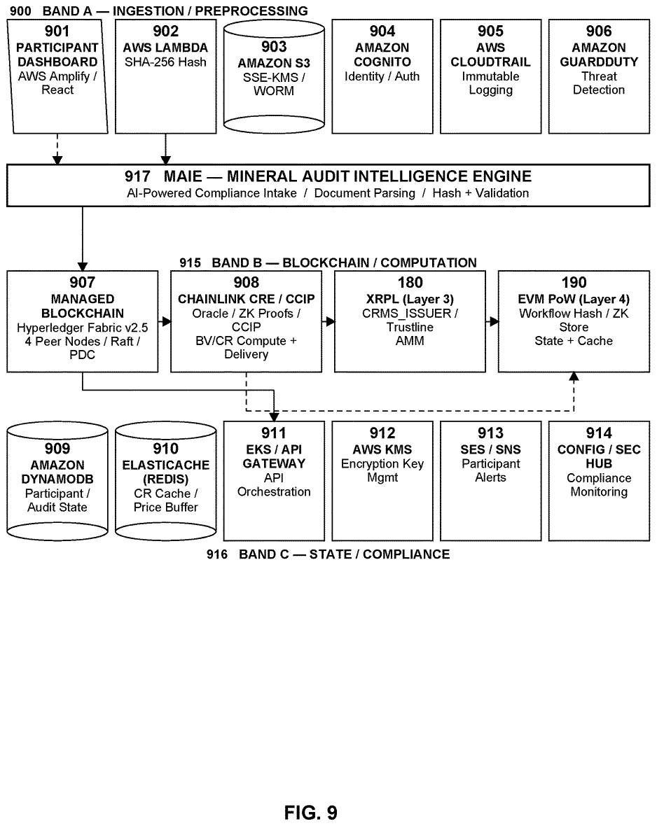

Referring to FIG. 9, in at least one embodiment, the architecture 100 is implemented on a cloud infrastructure reference architecture supporting the first layer 110 and the second layer 120, the cloud infrastructure reference architecture being organized into an ingestion and preprocessing band, a blockchain and computation band, and a state management and compliance band. In at least one embodiment, the ingestion and preprocessing band comprises a participant access interface implemented as a web-based dashboard, as disclosed in U.S. Provisional Patent Application No. 63/835,006 at element 101.

In at least one embodiment, each of the first layer 110, the second layer 120, the third layer 130, and the fourth layer 140 is implemented on one or more computer hardware processors, one or more memory devices, and one or more network interfaces, where the one or more memory devices and the one or more network interfaces are communicatively coupled to the one or more computer hardware processors. In at least one embodiment, the one or more memory devices comprise one or more non-transitory computer-readable storage media having program instructions stored thereon which, when executed by the one or more computer hardware processors, cause the one or more computer hardware processors to perform operations attributed herein to the corresponding layer.

In at least one embodiment, the program instructions further comprise instructions to instantiate, on the permissioned settlement ledger 180, a stablecoin token data structure 600 as described in connection with FIGS. 6E and 6F, and to maintain the stablecoin token data structure 600 throughout the lifecycle of each issued stablecoin token.

In at least one embodiment, the program instructions are distributed across a plurality of computer hardware processors operating in geographically distinct locations and connected through one or more public or private networks. In at least one embodiment, one or more components of the architecture 100 are implemented through hardware-based trusted execution environments configured to perform off-chain confidential computation, in at least one embodiment including Intel Software Guard Extensions (SGX) secure enclaves or equivalent trusted execution environments.

Disclosed embodiments may be implemented in numerous specific details to provide a thorough understanding of the embodiments. It will be understood, however, by one of ordinary skill in the art that the embodiments may be practiced without such specific details, that the embodiments are not limited to the specific embodiments described, and that the embodiments may be practiced with various modifications, alterations, and substitutions. The specific arrangements and combinations of components, message types, threshold values, mineral constituents, jurisdictional selections, and proof systems described herein are exemplary and non-limiting, and any equivalent arrangement that performs the functions attributed herein is contemplated as falling within the scope of the appended claims. The use throughout this specification of terms such as “in at least one embodiment,” “configured to,” “operable to,” “adapted to,” “some implementations,” “a preferred embodiment,” and similar phrases is intended to describe non-limiting aspects of the disclosed embodiments and shall not be construed to limit the scope of the appended claims.

It is to be understood that the foregoing Detailed Description is exemplary only and does not constrain the scope of the appended claims. The appended claims define the scope of the protection sought by this application, and any embodiments or features not claimed in the appended claims are intended to be reserved for later claim presentation in one or more continuation or divisional applications under 35 U.S.C. § 120 or 35 U.S.C. § 121.

What is claimed is:

1. A system for converting independently audited critical mineral reserve data into a collateralized stablecoin instrument, the system comprising one or more computer hardware processors, one or more memory devices, and one or more network interfaces collectively configured to implement:
(a) a first layer comprising a permissioned distributed ledger network configured to receive an audit document selected from the group consisting of a geological reserve audit document and a yield audit document, compute a cryptographic hash of the audit document, store the audit document in a private data collection of the permissioned distributed ledger network while recording only the cryptographic hash on the distributed ledger, execute chaincode logic to validate Foreign Entity of Concern compliance, Environmental Social and Governance compliance, and audit-standard compliance conditions, and emit a signed validation event upon concurrent satisfaction of all three conditions;
(b) a second layer comprising a decentralized oracle computation network and a cross-chain interoperability protocol, communicatively coupled to the first layer, configured to receive the signed validation event, retrieve commodity price data for each constituent of a governance-weighted basket, compute a basket value as a weighted sum of (i) audit-validated reserve quantities, (ii) commodity prices adjusted by a jurisdictional risk coefficient and a volatility dampener, and (iii) governance-set allocation weights, compute a collateral ratio by dividing the basket value by a proposed stablecoin supply quantity, block any minting authorization where the collateral ratio is below a defined over-collateralization threshold, and generate a zero-knowledge collateral sufficiency proof attesting to satisfaction of the over-collateralization threshold without disclosing the reserve quantities, mineral grades, or geospatial coordinates;
(c) a third layer comprising a permissioned settlement ledger configured to receive a minting authorization from the second layer through the cross-chain interoperability protocol, execute stablecoin token issuance, redemption, and burn operations from a single authoritative issuer account under a multi-signature governance threshold drawn from a plurality of distinct supply chain participant classes, and restrict token holding, receipt, and transfer to wallets having an active trustline authorization conditioned on validation of the wallet holder's audit status and Foreign Entity of Concern compliance through a Membership Service Provider of the first layer; and
(d) a fourth layer comprising a public permissionless attestation contract deployed on a public blockchain and configured to immutably store, for each protocol operation, a workflow commitment hash, outputs of the zero-knowledge collateral sufficiency proof, cross-chain interoperability execution receipts, and governance vote commitment hashes, and to expose a publicly accessible cryptographic verification interface.

2. The system of claim 1, wherein:
(a) the permissioned distributed ledger network of the first layer comprises a Hyperledger Fabric network having peer nodes operating under a Raft consensus protocol;
(b) the decentralized oracle computation network and the cross-chain interoperability protocol of the second layer comprise a Chainlink Runtime Environment and a Chainlink Cross-Chain Interoperability Protocol, respectively;
(c) the permissioned settlement ledger of the third layer comprises an XRP Ledger permissioned domain;
(d) the public permissionless attestation contract of the fourth layer comprises an Ethereum Virtual Machine-compatible smart contract; and
(e) the cryptographic hash comprises a SHA-256 hash and the over-collateralization threshold comprises a collateral ratio of 1.30.

3. The system of claim 1, further comprising a Mineral Reserve Receipt programmable escrow subsystem integrated within the third layer, the Mineral Reserve Receipt programmable escrow subsystem comprising:
(a) a Mineral Reserve Receipt token representing a quantity of stablecoin held in a multi-signature escrow address requiring authorization from (i) the second layer as a cryptographically authenticated protocol authorization signal delivered through the cross-chain interoperability protocol, (ii) an initiating participant holding a first-layer-issued identity credential, and (iii) a designated beneficiary holding a first-layer-issued identity credential;
(b) on-ledger conditional release logic implemented as hook-based smart logic natively executed on the third layer and configured to release the locked stablecoin to the beneficiary wallet exclusively upon receipt of a valid zero-knowledge escrow milestone proof transmitted from the second layer through the cross-chain interoperability protocol, the on-ledger conditional release logic being structurally incapable of releasing the locked stablecoin by any pathway other than zero-knowledge-proof-conditioned cross-chain message delivery; and
(c) an immutable Mineral Reserve Receipt lifecycle record anchored on the fourth layer comprising cryptographic hashes of an escrow creation event, each condition monitoring event, and a release or expiry event, together with corresponding zero-knowledge proof outputs.

4. The system of claim 1, wherein the second layer is further configured to generate a Collateral Sufficiency Circuit operating at a boundary between the second layer and the third layer, wherein:
(a) private inputs to the Collateral Sufficiency Circuit comprise reserve quantities Rᵢ for each mineral constituent i in the governance-weighted basket, jurisdictional risk coefficients kᵢ, and volatility dampeners λᵢ;
(b) public inputs to the Collateral Sufficiency Circuit comprise oracle prices Pᵢ retrieved from a data feed of the decentralized oracle computation network, governance-set basket allocation weights Wᵢ, and a proposed stablecoin supply quantity S;
(c) the Collateral Sufficiency Circuit computes an adjusted price for each constituent according to the relation \tilde{P}ᵢ=Pᵢ·kᵢ·λᵢ, computes the basket value as BV =Σᵢ (Rᵢ·\tilde{P}ᵢ·Wᵢ), and computes the collateral ratio as CR =BV ÷S; and
(d) the public output of the Collateral Sufficiency Circuit is a Boolean proof attesting that CR satisfies the over-collateralization threshold without revealing the reserve quantities Rᵢ, the jurisdictional risk coefficients kᵢ, or the volatility dampeners λᵢ.

5. The system of claim 1, wherein every issued stablecoin token is simultaneously collateralized at three tiers comprising:
(a) a Tier 1 primary collateral position validated through the first layer at a defined minimum over-collateralization ratio, the Tier 1 primary collateral position being selected from a geological reserve audit position and a yield audit position;
(b) a Tier 2 sovereign guarantee processed through a Sovereign Guarantee Channel of the first layer, the Sovereign Guarantee Channel being implemented as a permissioned private data channel segregated from each audit data channel and each compliance data channel of the first layer and being configured to receive and validate sovereign mineral collateral declarations executed by authorized state sovereign representatives against state and federal land agency records without requiring submission of proprietary geological audit content; and
(c) a Tier 3 federal sovereign reserve backstop designation cryptographically verified through an on-chain proof-of-reserve attestation anchored on the fourth layer.

6. The system of claim 1, wherein the plurality of distinct supply chain participant classes includes at least mining operators, geological auditors, refiners and smelters, recyclers and secondary processors, original equipment manufacturer end-users, special purpose depository institution custodians, oracle and infrastructure validators, government and sovereign representatives, and a protocol foundation entity.

7. A method for converting independently audited critical mineral reserve data into a collateralized stablecoin instrument, the method comprising, by at least one computer processor:
(a) receiving, at a permissioned distributed ledger network, an audit document selected from a geological reserve audit document and a yield audit document;
(b) computing a cryptographic hash of the audit document, storing the audit document in a private data collection of the permissioned distributed ledger network, recording only the cryptographic hash on the distributed ledger, and executing chaincode logic to validate Foreign Entity of Concern compliance, Environmental Social and Governance compliance, and audit-standard compliance conditions;
(c) emitting a signed validation event upon concurrent satisfaction of all three conditions of step (b);
(d) at a decentralized oracle computation network, computing a basket value as a weighted sum of audit-validated reserve quantities multiplied by jurisdictionally-adjusted and volatility-dampened commodity prices and governance-set allocation weights, computing a collateral ratio by dividing the basket value by a proposed stablecoin supply quantity, blocking any minting authorization where the collateral ratio is below a defined over-collateralization threshold, and generating a zero-knowledge collateral sufficiency proof attesting to satisfaction of the over-collateralization threshold without disclosing the reserve quantities, mineral grades, or geospatial coordinates;
(e) transmitting, through a cross-chain interoperability protocol, a minting authorization comprising the zero-knowledge collateral sufficiency proof and an approved mint quantity from the decentralized oracle computation network to a permissioned settlement ledger;
(f) at the permissioned settlement ledger, issuing, redeeming, or burning stablecoin tokens through a single authoritative issuer account operating under a multi-signature governance threshold drawn from a plurality of distinct supply chain participant classes, restricted to destination wallets having active trustline authorization conditioned on validation of the wallet holder's audit status and Foreign Entity of Concern compliance through a Membership Service Provider of the permissioned distributed ledger network;
(g) transmitting, through the cross-chain interoperability protocol, a workflow commitment hash and outputs of one or more zero-knowledge proof circuits to a public permissionless attestation contract deployed on a public blockchain for immutable public registration; and
(h) monitoring the collateral ratio against oracle prices on a recurring basis and initiating a proportional stablecoin burn operation by delivering a burn authorization through the cross-chain interoperability protocol to the permissioned settlement ledger upon any breach of the over-collateralization threshold.

8. The method of claim 7, wherein:
(a) the permissioned distributed ledger network comprises a Hyperledger Fabric network;
(b) the decentralized oracle computation network comprises a Chainlink Runtime Environment;
(c) the cross-chain interoperability protocol comprises a Chainlink Cross-Chain Interoperability Protocol;
(d) the permissioned settlement ledger comprises an XRP Ledger permissioned domain;
(e) the public permissionless attestation contract comprises an Ethereum Virtual Machine-compatible smart contract; and
(f) the over-collateralization threshold comprises a collateral ratio of 1.30.

9. The method of claim 7, further comprising:
(a) receiving, from a first participant holding a first-layer-issued identity credential, a programmable escrow contract request specifying a stablecoin amount, a designated beneficiary, and a defined set of release conditions tied to verifiable mineral supply chain events;
(b) locking the specified stablecoin amount in a multi-signature escrow address on the permissioned settlement ledger and minting a Mineral Reserve Receipt token to the first participant;
(c) monitoring, by the decentralized oracle computation network, the defined release conditions and generating, upon satisfaction of all release conditions, a zero-knowledge escrow milestone proof;
(d) releasing the locked stablecoin to the designated beneficiary's trustline-authorized wallet by hook-based on-ledger conditional logic upon receipt of the zero-knowledge escrow milestone proof, the hook-based on-ledger conditional logic being structurally incapable of releasing the locked stablecoin by any pathway other than zero-knowledge-proof-conditioned cross-chain message delivery; and
(e) burning or updating the Mineral Reserve Receipt token and anchoring a complete escrow lifecycle record on the public permissionless attestation contract.

10. The method of claim 7, wherein computing the basket value comprises:
(a) for each critical mineral constituent i in the governance-weighted basket, computing an adjusted price \tilde{P}ᵢ according to the relation \tilde{P}ᵢ=Pᵢ·kᵢ ·λᵢ, wherein Pᵢ is a real-time commodity price retrieved from a data feed retrieving data from a professional commodity pricing source comprising at least one of Benchmark Mineral Intelligence, Fastmarkets, or S&P Global Commodity Insights, kᵢ is a jurisdictional risk coefficient specific to a verified jurisdiction of origin recorded in the audit document, and λᵢ is a volatility dampener that reduces the effective price input during periods of elevated commodity price volatility;
(b) computing the basket value BV according to the relation BV =Σᵢ (Rᵢ·\tilde{P}ᵢ·Wᵢ), wherein Rᵢ is the audit-validated reserve quantity for constituent i and Wᵢ is the governance-set allocation weight for constituent i; and
(c) computing the collateral ratio CR according to the relation CR=BV÷S, wherein S is the proposed stablecoin supply quantity, and wherein the minting authorization is blocked unless CR satisfies the over-collateralization threshold.

11. A system for issuing and managing a critical-mineral-collateralized stablecoin token, the system comprising at least one computer hardware processor and at least one non-transitory computer-readable storage medium having instructions stored thereon which, when executed by the at least one computer hardware processor, cause the at least one computer hardware processor to instantiate and maintain a stablecoin token data structure on a permissioned settlement ledger, the stablecoin token data structure comprising:
(a) a token identifier field;
(b) a three-tier collateral binding reference field comprising (i) a Tier 1 primary collateral reference recorded on a permissioned distributed ledger network, (ii) a Tier 2sovereign guarantee reference recorded through a Sovereign Guarantee Channel of the permissioned distributed ledger network, and (iii) a Tier 3 federal sovereign reserve backstop reference;
(c) a zero-knowledge-verified compliance flag field comprising at least three flags, each flag being settable only upon successful execution of a corresponding zero-knowledge proof circuit operating at a defined inter-layer boundary;
(d) a multi-signature authorization record field storing cryptographic signatures from a multi-signature governance threshold drawn from a plurality of distinct supply chain participant classes;
(e) a trustline authorization record field, the trustline authorization record field being settable only upon validation of the holder wallet's audit status and Foreign Entity of Concern compliance through a Membership Service Provider of the permissioned distributed ledger network; and
(f) a multi-layer attestation anchoring reference field referencing an immutable record of an issuance event on a public permissionless attestation contract deployed on a public blockchain.

12. The system of claim 11, wherein:
(a) the at least three flags of the zero-knowledge-verified compliance flag field comprise a Foreign Entity of Concern compliance flag, an Environmental Social and Governance compliance flag, and an audit compliance flag;
(b) the trustline authorization record field further comprises a credential identifier referencing an identity credential of the wallet holder issued by the Membership Service Provider, an audit status validation timestamp, and a Foreign Entity of Concern compliance validation timestamp; and
(c) the at least one non-transitory computer-readable storage medium further stores instructions that, when executed by the at least one computer processor, cause the system to deactivate the trustline authorization record field upon detection of a change in audit status or Foreign Entity of Concern compliance associated with the credential identifier.
